(19) United States
(12) Patent Application Publication
(10) Pub. No.: US 2024/0296011 A1
(43) Pub. Date: Sep. 5, 2024

(54) ADDITION CIRCUITRY

(71) Applicant: Arm Limited, Cambridge (GB)

(72) Inventor: Jørn NYSTAD, Trondheim (NO)

(21) Appl. No.: 18/117,210

(22) Filed: Mar. 3, 2023

(51) Int. Cl. G06F 7/508

(52) U.S. Cl. CPC G06F 7/508

(57) ABSTRACT

Addition circuitry performs a saturating addition of a first number and a second number to generate a result value indicating an addition result corresponding to addition of the first number and the second number when the addition result is within a predetermined range and indicating a saturation value when the addition result is outside the predetermined range. The addition circuitry comprises: saturation lookahead circuitry to determine, for each lane of the result value, a respective set of one or more saturation lookahead status indications indicative of whether that lane should be set to represent part of the saturation value; and addition result generating circuitry to generate result bits for each lane, with a given lane of the result value having a value determined as a function of corresponding bits of the first and second numbers and a corresponding set of one or more saturation lookahead status indications determined for that lane by the saturation lookahead circuitry.

### BACKGROUND

### Technical Field

The present technique relates to the field of data processing.

### Technical Background

Implementation of addition circuitry for adding two numbers can be a challenge for meeting performance demands, as there can be additional complexity in handling carries that may be generated in one lane of the addition and may propagate up to other lanes.

### SUMMARY

At least some examples of the present technique provide an apparatus comprising:
addition circuitry to perform a saturating addition of a first number and a second number to generate a result value, the result value indicating an addition result corresponding to addition of the first number and the second number when the addition result is within a predetermined range and indicating a saturation value when the addition result is outside the predetermined range;
the addition circuitry comprising:
   saturation lookahead circuitry to determine, for each lane of the result value, a respective set of one or more saturation lookahead status indications indicative of whether that lane of the result value should be set to represent part of the saturation value; and
   addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.

At least some examples provide a non-transitory computer-readable medium to store computer-readable code for fabrication of an apparatus comprising:
addition circuitry to perform a saturating addition of a first number and a second number to generate a result value, the result value indicating an addition result corresponding to addition of the first number and the second number when the addition result is within a predetermined range and indicating a saturation value when the addition result is outside the predetermined range;
the addition circuitry comprising:
   saturation lookahead circuitry to determine, for each lane of the result value, a respective set of one or more saturation lookahead status indications indicative of whether that lane of the result value should be set to represent part of the saturation value; and
   addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.

At least some examples provide a method for performing, using addition circuitry comprising saturation lookahead circuitry and addition result generating circuitry, a saturating addition of a first number and a second number to generate a result value, the result value indicating an addition result corresponding to addition of the first number and the second number when the addition result is within a predetermined range and indicating a saturation value when the addition result is outside the predetermined range; the method comprising:
determining, for each lane of the result value using the saturation lookahead circuitry, a respective set of one or more saturation lookahead status indications indicative of whether that lane of the result value should be set to represent part of the saturation value; and
generating result bits for each lane of the result value using the addition result generating circuitry, with a given lane of the result value having a value determined as a function of corresponding bits of the first number and the second number and a corresponding set of one or more saturation lookahead status indications determined for that lane by the saturation lookahead circuitry.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing apparatus;

FIG. 2 illustrates an example of addition circuitry;

FIG. 3 illustrates an example of addition result generation circuitry;

FIG. 4 shows an example of carry lookahead circuitry;

FIG. 5 shows an example of saturation lookahead circuitry for an unsigned addition;

FIGS. 6 and 7 illustrate saturation lookahead circuitry for a signed addition, for generating signed overflow saturation lookahead status indications and signed underflow saturation lookahead status indications respectively;

FIGS. 8 to 10 illustrate examples of sharing circuitry between the carry lookahead circuitry and the saturation lookahead circuitry;

FIG. 11 illustrates an example of applying the carry lookahead status values and saturation lookahead status values in different orders for upper and lower lanes of the result value;

FIGS. 12 and 13 illustrate parts of the addition result generation circuitry for generating, for an unsigned saturating addition, bit values for lower and upper lanes of the result value respectively;

FIGS. 14, 15 and 16 illustrate parts of the addition result generation circuitry for generating, for a signed saturating addition, bit values for lower, upper and most significant lanes respectively; and

FIG. 17 is a flow chart illustrating a method of processing a saturating add instruction using addition circuitry.

### DESCRIPTION OF EXAMPLES

One type of arithmetic operation that may be desired to be supported by a processor is a saturating addition of two numbers to generate a result value. For a saturating addition, the result value indicates an addition result corresponding to addition of the first number and the second number when the addition result is within a predetermined range, but indicates a saturation value when the addition result is outside the predetermined range. Hence, values of the addition result outside the predetermined range are clamped to the saturation value (typically the minimum or maximum of the range). This differs from modular arithmetic where values exceeding the maximum of the range will wrap around to the minimum value or values less than the minimum value would wrap around to the maximum value. While the arithmetic operation for the saturating addition is well-defined, there is design choice to be made in how to implement hardware circuit logic for performing that operation within a processor. Design decisions made by the circuit designer may have an impact on processing performance.

One might think that, to implement a saturating addition, it would be needed to first perform the addition in a non-saturating manner to obtain the addition result in a wider range than the predetermined range, then compare the addition result with a threshold to determine whether it is within the predetermined range, and if the addition result is outside the predetermined range, set the result value to the saturation value while otherwise setting the result value to the addition result. However, this approach would add extra delay in obtaining the result value for a saturating addition compared to a standard non-saturating addition, due to the extra steps of comparing the addition result with the threshold and clamping the result value to the saturation value if the comparison determines that the result is out of range.

In the examples below, an apparatus comprises addition circuitry to perform a saturating addition of a first number and a second number to generate a result value, the result value indicating an addition result corresponding to addition of the first number and the second number when the addition result is within a predetermined range and indicating a saturation value when the addition result is outside the predetermined range. The addition circuitry comprises saturation lookahead circuitry to determine, for each lane of the result value, a respective set of one or more saturation lookahead status indications indicative of whether that lane of the result value should be set to represent part of the saturation value; and addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.

Hence, by generating lane-by-lane saturation lookahead status indications each indicating whether a corresponding lane of the result value should be set to represent part of the saturation value, each lane of the result can be set as a function of the corresponding bits of the first and second numbers and one or more saturation lookahead status indications for that lane. This can eliminate the comparison step mentioned above, allowing for faster determination of the result of the saturating addition.

The saturation lookahead status indications may be generated without waiting for availability of any value representing the addition result indicating the numeric result of adding the first number and the second number. Hence, the saturation lookahead status indications may be generated directly from logical combinations of bits from the first and second numbers, rather than being derived from the addition result. As the saturation lookahead status indications may be available before any addition result is calculated, this allows for faster processing of the saturating addition.

The result bits for respective lanes of the result value may be generated in parallel by the addition result generating circuitry. For example, the addition result generating circuitry may comprise a number of lane value generating circuits, each lane value generating circuit generating a value for a corresponding lane of the result value as a function of (at least) the corresponding bits of the first and second numbers and the corresponding set of one or more saturation lookahead status indications determined for that lane. The lane value generating circuits may calculate their respective lane values in parallel.

The saturation lookahead circuitry may be configured to determine initial saturation lookahead status indications for each lane based on corresponding bits of the first number and the second number for that particular lane; and to combine the initial saturation lookahead status indications to generate the saturation lookahead status indications for lanes other than the most significant lane, where a given saturation lookahead status indication for a given lane other than a most significant lane depends on a combination of the initial saturation lookahead status indications for the given lane and any more significant lane than the given lane. In practice the delay associated with generating the respective combinations of the initial saturation lookahead status indications may be less than the delay which would have occurred if waiting for the addition result to be available before comparing the addition result with a threshold to determine whether the result is saturated. Therefore, this approach of generating the saturation lookahead status indications so can improve performance compared to alternative techniques.

The initial saturation lookahead status indication determined for the most significant lane does not need to be combined with any other initial saturation lookahead status indications for other lanes, because the saturation lookahead status indication for the most significant lane is simply equal to the saturation lookahead status indication for the most significant lane (as there are no other lanes more significant than that lane, there is no need for a combination).

The saturation lookahead circuitry may combine the initial saturation lookahead status indications using a top-down parallel-prefix-sum network. A prefix sum operation is an operation which generates a sequence of output results where successive members of the sequence of output results depend on combinations of successively increasing numbers of input values. The combination operations performed to combine the initial saturation lookahead status indications to generate the saturation lookahead status indications can be implemented as a top-down parallel prefix sum, since the saturation lookahead status indication for a given lane depends on the initial saturation lookahead status indications for that lane and any more significant lane. A parallel-prefix-sum network is an efficient circuit structure for implementing prefix sum operations, as it can allow some of the combinations to occur in parallel, performed in a number of stages each involving a certain number of parallel combinations applied to different inputs. The parallel-prefix-sum network comprises a number of combination units (each combining two inputs to product one output according to a certain logical function) arranged in several stages in a binary tree, where outputs of combination units at one stage can be used as inputs in the following stage and by the end of the final stage all of the required combinations are complete. For a prefix sum applied to 2^{N} input values, this can be done in N stages of combination units using the parallel prefix-sum network, which can be faster than in alternative ways of ordering the combinations. A top-down parallel-prefix-sum network is used for computing the saturation lookahead status indications, as with the top-down approach, as the initial saturation lookahead status indication for the most significant lane would be included in the combinations for each of the other lanes, and the output saturation lookahead status value which is dependent on the greatest number of initial saturation lookahead status values is the saturation lookahead status value for the least significant lane.

The addition circuitry may also comprise carry lookahead circuitry to determine a plurality of carry lookahead status indications each corresponding to a respective lane of the result value other than a most significant lane, each carry lookahead status indication indicative of whether a carry out would be generated from a corresponding lane in an addition of the first number and the second number. For a lane of the result value other than a least significant lane, the addition result generating circuitry is configured to generate that lane of the result value as a function of the corresponding bits of the first number and the second number, the corresponding set of one or more saturation lookahead status indications determined for that lane by the saturation lookahead circuitry, and the carry lookahead status indication determined for a next least significant lane by the carry lookahead circuitry. Computing carry lookahead status indications in advance based on analysis of bits of the first and second numbers can speed up generating a value representing the result of an addition of the first and second numbers, compared to propagating carries sequentially up from the least significant lane to the most significant lane. This allows lane-by-lane calculation of the result bits for respective lanes to be parallelised rather than calculated sequentially, since each lane's result bit can be computed as a Boolean function of the corresponding bits of the first and second number, the corresponding set of one or more saturation lookahead status indications, and the carry lookahead status indication, rather than needing to depend on results calculated for lower lanes as in a carry-propagate addition. This helps to improve performance.

For some implementations of the saturating addition (e.g. a saturating addition with carry), the result bit for a given lane may also depend on a carry input at the least significant lane, in addition to the corresponding bits of the first number and the second number, the corresponding set of one or more saturation lookahead status indications determined for that lane by the saturation lookahead circuitry, and the carry lookahead status indication determined for a next least significant lane by the carry lookahead circuitry.

There is no need to calculate a carry lookahead status indication for the most significant lane, because that lane's carry out is not needed to determine a value of any higher lane.

The carry lookahead circuitry may be configured to: determine initial carry lookahead status indications for each lane other than the most significant lane, based on corresponding bits of the first number and the second number; and combine the initial carry lookahead status indications to generate the carry lookahead status indications for lanes other than the least significant lane, where a given carry lookahead status indication for a given lane other than a least significant lane and the most significant lane depends on a combination of the initial carry lookahead status indications for the given lane and any less significant lane than the given lane. Hence, a similar set of combinations may be performed to generate the carry lookahead status indications as is done for the saturation lookahead status indications, but with the difference that the combinations are in a different pattern—for the carry lookahead status indications the combinations are bottom-up combinations where the “scan sequence” of combinations starts from the least significant end instead of top-down combinations starting from the most significant end. A given lane's carry lookahead status indication depends on the initial carry lookahead status indication for that given lane and any less significant lane, in contrast to the given lane's saturation lookahead status indication which depends on initial saturation lookahead status indications for that given lane and any more significant lane.

The initial carry lookahead status indication for the least significant lane does not require any combination with other initial carry lookahead status indications for other lanes, because the carry lookahead status indication for the least significant lane is simply equal to the initial carry lookahead status indication for the least significant lane (if the bottom lane's bits from the first and second numbers are such that they will generate a carry when added, then the carry will be generated regardless of the values of bits in other higher lanes).

The carry lookahead circuitry may be configured to combine the initial carry lookahead status indications using a bottom-up parallel-prefix-sum network. Again, a parallel-prefix-sum network can be helpful to speed up performance. In contrast to the top-down parallel-prefix-sum network used for the saturation lookahead circuitry, the carry lookahead circuitry uses a bottom-up parallel-prefix-sum network, for which the initial carry lookahead status indication for the least significant lane is to be included in the combinations for generating the output carry lookahead status indications for each higher lane other than the most significant lane, and the lane whose final carry lookahead status value depends on the greatest number of initial carry lookahead status value is the second most significant lane (as mentioned earlier, it is not necessary to calculate a carry lookahead status value for the most significant lane).

In some examples, the saturation lookahead circuitry and the carry lookahead circuitry may be separate, with no shared hardware circuit logic.

However, in other examples, the saturation lookahead circuitry and the carry lookahead circuitry may share a portion of hardware circuit logic used for both determination of the saturation lookahead status indication for at least one lane and determination of the carry lookahead status indication for at least one lane. The inventor recognised that it is possible to choose encodings for the saturation lookahead status values and carry lookahead status values so that some of the Boolean functions for performing the combinations of saturation/carry lookahead status values become the same and can be generated from identical inputs, which means that some of the circuit logic can be shared. Due to the difference between the top-down prefix scan used for the saturation lookahead status indication calculation and the bottom-up prefix scan used for the carry lookahead status indication, there will be some non-shared hardware circuit logic which is only used for either the saturation lookahead circuitry or the carry lookahead circuitry, but a significant fraction of the circuit logic can be shared to avoid duplication, which is helpful to reduce the circuit area and power consumption of the addition circuitry.

In some examples, for a lane in a less significant subset of lanes of the result value, the addition result generating circuitry is configured to apply the carry lookahead status indication to the corresponding bits of the first number and the second number, before applying the corresponding set of one or more saturation lookahead status indications; and for a lane in a more significant subset of lanes of the result value, the addition result generating circuitry is configured to apply the corresponding set of one or more saturation lookahead status indications to the corresponding bits of the first number and the second number, before applying the carry lookahead status indication. This approach can improve performance. The inventor recognised that, due to the difference between the top-down and bottom-up prefix scans used for generating the saturation/carry lookahead status indications respectively, for more significant lanes the saturation lookahead status indications require fewer stages of combination than the carry lookahead status indications, while for less significant lanes the carry lookahead status indications require fewer stages of combination than the saturation lookahead status indication. Hence, for the less significant subset of lanes, the carry lookahead status indications can be ready earlier than the saturation lookahead status indications, and so the corresponding result bits can be calculated faster by applying the carry lookahead status indication before the one or more saturation lookahead status indications. In contrast, for the more significant subset of lanes, the result bits can be calculated faster by applying the one or more saturation lookahead status indications before the carry lookahead status indication, because the saturation lookahead status indications will be ready earlier than the carry lookahead status indications. Hence, by applying the saturation and carry lookahead status indications in a different order for the more significant lanes compared to the less significant lanes, performance can be improved.

One might think that the carry lookahead status indication would be needed to allow the saturation lookahead status indication to be applied to the first and second bits to generate the result bit (e.g. so that a value of the corresponding bit of the addition result for the first and second numbers can be calculated before applying the required saturation if necessary). However, this can be overcome by speculatively generating two different candidate values to cover alternative outcomes that could occur (if either the carry lookahead status indication indicates that a carry in is to be applied in that lane, or the carry lookahead status indication indicates there is no such carry in), and then selecting between these candidate values once the carry lookahead status indication is available. Hence, for a lane in the more significant subset of lanes of the result value, the addition result generating circuitry may generate first and second candidate values for that lane of the result value based on the corresponding bits of the first number and the second number and the corresponding set of one or more saturation lookahead status indications, and select between the first and second candidate values based on a carry value derived from the carry lookahead status indication. This helps to improve performance by allowing the saturation lookahead status indication to be applied earlier once calculated by the saturation lookahead circuitry, even if the corresponding carry lookahead status indication is not ready yet.

The saturation lookahead circuitry may determine the initial saturation lookahead status indication for each lane to indicate one of:
a first state, in a case where addition of the corresponding bits of the first number and the second number would not produce an overflow or underflow;
a second state, in a case where addition of the corresponding bits of the first number and the second number would unconditionally produce an overflow or underflow; and
a third state, in a case where whether or not an addition of the corresponding bits of the first number and the second number produces an overflow or underflow is conditional on whether a carry input for that lane is set.

Similarly, each intermediate saturation lookahead status indication resulting from combinations of initial saturation lookahead status indications by the saturation lookahead circuitry, and the final saturation lookahead status indication computed by the saturation lookahead circuitry for a given lane, may also have such an encoding indicating one of the first, second and third states, but for the intermediate saturation lookahead status indications, the states now indicate whether addition of values in corresponding multi-bit portions of the first and second numbers would not produce an overflow (first state), would unconditionally produce an overflow or underflow (second state) or would conditionally produce an overflow or underflow conditional on the carry input for that multi-bit portion being set (third state).

When combining saturation lookahead status indications for first and second lane subsets each comprising one or more lanes, where the second lane subset is less significant than the first lane subset, the saturation lookahead circuitry is configured to:
determine that a combined saturation lookahead status indication for the first and second lane subsets has the first state, when the saturation lookahead status indication for the first lane subset has the first state;
determine that the combined saturation lookahead status indication for the first and second lane subsets has the second state, when the saturation lookahead status indication for the first lane subset has the second state; and
determine that the combined saturation lookahead status indication for the first and second lane subsets is equal to the saturation lookahead status indication for the second lane subset, when the saturation lookahead status indication for the first lane subset has the third state.

In each combination of two saturation lookahead status indications, those two saturation lookahead status indications could be two initial saturation lookahead status indications determined based on the bits of the first and second numbers, or two previously combined intermediate saturation lookahead status indications generated at a previous stage of combinations, or could be one initial saturation lookahead status indication and one previously combined intermediate saturation lookahead status indication.

With this approach, once all the combinations have been carried out, each lane will end up with their saturation lookahead status indications in the same state as all other lanes, indicating whether the result value as a whole is not saturated (in the first state), the result value as a whole is saturated (in the second state), or that whether the result value is saturated will depend on a carry input at the least significant lane (in the third state). These values can be used by the addition result generating circuitry in a parallel lane-by-lane calculation to generate the bits in respective lanes of the addition result value, so that there is no need for a subsequent comparison against a saturation threshold after the addition result is calculated.

The saturating addition can be implemented either as an unsigned saturating addition or as a signed saturating addition. Some implementations may only support one of these options. Other implementations may support both signed and unsigned saturating additions.

In some implementations, for an unsigned saturating addition where the predetermined range extends from zero to a positive limit value, the saturation lookahead circuitry is configured to generate an unsigned overflow saturation lookahead status indication for each lane indicative of whether the corresponding lane should be set to part of the saturation value; and the addition result generating circuitry is configured to generate the given lane with a value determined as a function of corresponding bits of the first number and the second number and the unsigned overflow saturation lookahead status indication determined for that lane by the saturation lookahead circuitry. In this case, the saturation value can be either the positive limit value (where the addition represents an add operation A+B) or zero (where the addition represents a subtract operation A-B, by performing an addition of A+(—B), where-B is the negation of B).

In some implementations, for a signed saturating addition where the predetermined range extends from a negative limit value to a positive limit value, the saturation value is the negative limit value when the addition result is a negative number of greater magnitude than the negative limit value, and the saturation value is the positive limit value when the addition result is a positive number of greater magnitude than the positive limit value, the saturation lookahead circuitry is configured to generate, for each lane: (i) a signed overflow saturation lookahead status indication indicative of whether a corresponding lane should be set to part of the positive limit value, and (ii) a signed underflow saturation lookahead status indication indicative of whether the corresponding lane should be set to part of the negative limit value; and the addition result generating circuitry is configured to generate the given lane with a value determined as a function of corresponding bits of the first number and the second number and the signed overflow saturation lookahead status indication and the signed underflow saturation lookahead status indication determined for that lane by the saturation lookahead circuitry.

Hence, for signed saturating additions, each lane may be provided with two saturation lookahead status indications to represent the underflow and overflow cases (saturation to the negative limit value and positive limit value respectively). This contrasts with unsigned saturating addition where a single saturation lookahead status indication per lane is sufficient (since for an unsigned saturating addition there is no saturation at the lower end of the unsigned range, where zero is a valid unsaturated result).

For the signed saturating addition, the saturation lookahead circuitry may be configured to:
determine the signed overflow saturation lookahead status indication and the signed underflow lookahead status indication for a most significant lane, based on corresponding bits of the first number and the second number for the most significant lane;
determine, for lanes other than the most significant lane, initial unsigned overflow saturation lookahead status indications for each lane indicative of whether addition of corresponding bits of the first number and the second number would produce an unsigned overflow; and
generate, for a given lane other than the most significant lane:
   a signed overflow saturation lookahead status indication based on a combination of the initial signed overflow saturation lookahead status indication for the most significant lane and one or more initial unsigned overflow saturation lookahead status indications for the given lane and any lane more significant lane than the given lane but less significant than the most significant lane; and.
   a signed underflow saturation lookahead status indication based on a combination of the initial signed underflow saturation lookahead status indication for the most significant lane and one or more initial unsigned overflow saturation lookahead status indications for the given lane and any lane more significant lane than the given lane but less significant than the most significant lane.

For signed saturating additions of two's complement numbers, the overflow/underflow behaviour depends on whether there is a wraparound from 11 to 00 or from 01 to 10 at the top two lanes of the addition, so to distinguish the overflow and underflow cases, the initial signed overflow saturation lookahead status indication and initial signed underflow saturation lookahead status indication may be based on whether the first and second numbers both have a most significant bit of 0 (for the signed overflow saturation lookahead status indication) or both have a most significant bit of 1 (for the signed underflow saturation lookahead status indication). For remaining lanes, the initial saturation lookahead status indications set for those lanes based on bits of the first number and the second number can be the same for both overflow and underflow (set as an initial unsigned overflow saturation lookahead status indication generated based on the same Boolean functions as would be used for an unsigned addition), but the saturation lookahead circuitry may generate separate signed overflow/underflow saturation lookahead status indications for a given lane, by combining the initial signed overflow/underflow saturation lookahead status indication (respectively) for the most significant lane, the initial unsigned overflow saturation lookahead status indication for the given lane, and the initial unsigned overflow saturation lookahead status indication for any intervening lane. As separate calculations may be needed for computing the overflow/underflow statuses respectively, there may be multiple instances of the parallel prefix-sum tree to handle the overflow/underflow cases respectively.

Also, for a signed saturating addition, the function used by the addition result generating circuitry to compute the result bits for a given lane may be different for the most significant lane compared to the other lanes. The addition result generating circuitry may be configured to:
for a most significant lane, determine whether to saturate the lane to 0 depending on the signed overflow saturation lookahead status indication determined by the saturation lookahead circuitry for the most significant lane, and determine whether to saturate the lane to 1 depending on the signed underflow saturation lookahead status indication determined by the saturation lookahead circuitry for the most significant lane; and
for lanes other than the most significant lane, determine whether to saturate the lane to 1 depending on the signed overflow saturation lookahead status indication determined by the saturation lookahead circuitry for the most significant lane, and determine whether to saturate the lane to 0 depending on the signed underflow saturation lookahead status indication determined by the saturation lookahead circuitry for the most significant lane.

This reflects that for a signed saturating addition performed on numbers in two's complement form, the negative limit value is 0b100000 . . . and the positive limit value is 0b011111 . . . .

In the examples below, each “lane” of the result value corresponds to a single bit of the result value. However, it would also be possible to provide a higher-radix implementation where each lane corresponds to two or more bits of the result (in this case, the initial carry/saturation lookahead status indications may be derived from corresponding sets of multiple bits from the first and second numbers, with a slightly more complex logical function for deriving the initial lookahead status indications from bit patterns for the corresponding lanes of the first and second numbers). However, a single-bit per lane implementation can be simpler to implement.

The term “addition” is a generic term which encompasses both an add operation and a subtract operation. Subtraction is a form of addition because A-B can be implemented as an addition of A and the negation of B. For unsigned saturating subtraction, in the overflow case the saturation value would be 0 instead of the positive limit value with all bits set to 1. For signed saturating subtraction, the saturation values can be the same as for signed saturating adds, with no change other than that when performing a subtraction A-B, the B operand is negated before performing the same operations that would have been done on the non-negated version of B if an add operation A+B had been performed.

While examples below show use of 2's complement arithmetic, other examples could apply similar techniques to values represented in 1's complement representation.

### Apparatus Example

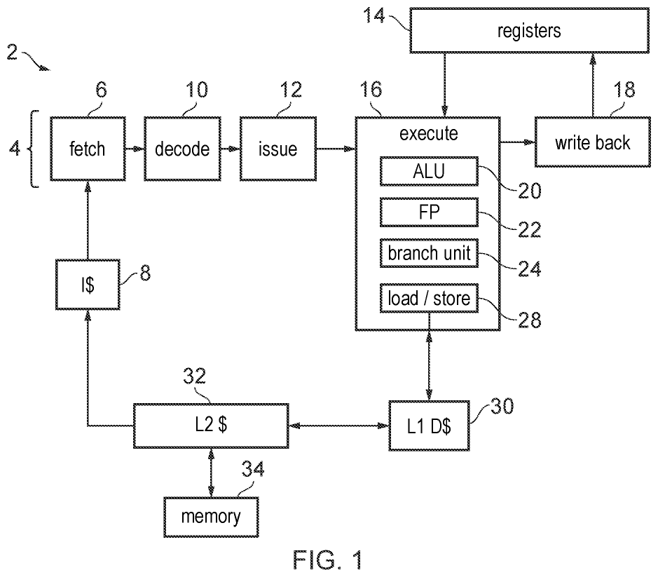

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetch program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. The integer ALU 20 and/or floating-point unit 22 may include addition circuitry for adding first and second numbers represented in two's complement form.

In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

### Overview of Saturating Addition

One type of arithmetic operation that can be supported by the processor 2 is a saturating addition. Saturating additions can be useful for use cases such as digital signal processing and neural network processing. The saturating addition is performed as a two's complement addition on first and second numbers A and B. The first and second numbers A and B may for example be integer operands or fixed-point operands. The result value generated in the saturating addition is either the result of the addition of A and B, when the addition result lies within a predetermined range, or a saturation value (the limit of the predetermined range) when addition result is outside the predetermined range.

The saturating addition can be performed with either signed or unsigned saturation.

For addition A+B with unsigned saturation, the two input numbers A and B are assumed to be two unsigned N-bit numbers, representing integers in the range 0 . . . 2^{N-1}. The saturating addition US(A+B) is then given by:
2^{N}−1 if A+B is 2^{N} or greater (unsigned overflow). This saturation value 2^{N}−1 is an N-bit value where all the bits are 1.
A+B otherwise (as the sum is not saturated).

For a subtraction A-B with unsigned saturation, the result is given by:
0 if A+−B is 2N or greater (where −B is the negation of B, e.g. the two's complement of B (a value equivalent to inverting all the bits of B and adding 1), and
A+−B otherwise.

For addition (including subtraction) with signed saturation, the two input numbers A and B are two signed N-bit numbers in the range −2^{N-1} . . . 2^{N-1}−1 (for a subtraction, the B operand is negated before applying the relations below on the negated version of B). The saturating addition SS(A+B) is then given by:
−2^{N-1} (negative limit value) if the sum A+B is less than −2^{N-1} (signed underflow). This saturation value is an N-bit value where the most significant bit is 1 and all remaining bits are 0.
2^{N-1}−1 (positive limit value) if the sum A+B is greater than or equal to 2^{N-1} (signed overflow). This saturation value is an N-bit value where the most significant bit is 0 and all remaining bits are 1.
A+B otherwise (as the sum is not saturated).

Hence, a naïve implementation of the saturating addition can be to compute the sum A+B; compare the sum to determine whether it lies outside the range; and if the sum is determined to be outside the range, clamp the result value to the maximum value in the range (for unsigned saturating add), to zero (for unsigned saturating subtract) or to either the maximum value or minimum value in the range (for signed saturation), depending on whether the sum has underflowed or overflowed. However, this approach would cause a saturating addition to be slower than a corresponding addition without saturation, due to the additional comparison and clamping steps. The approach discussed below provides a circuit for performing 2's complement signed or unsigned addition with saturation, designed in such a way that it does not impose any added gate delays over an adder without saturation.

### Addition Circuitry

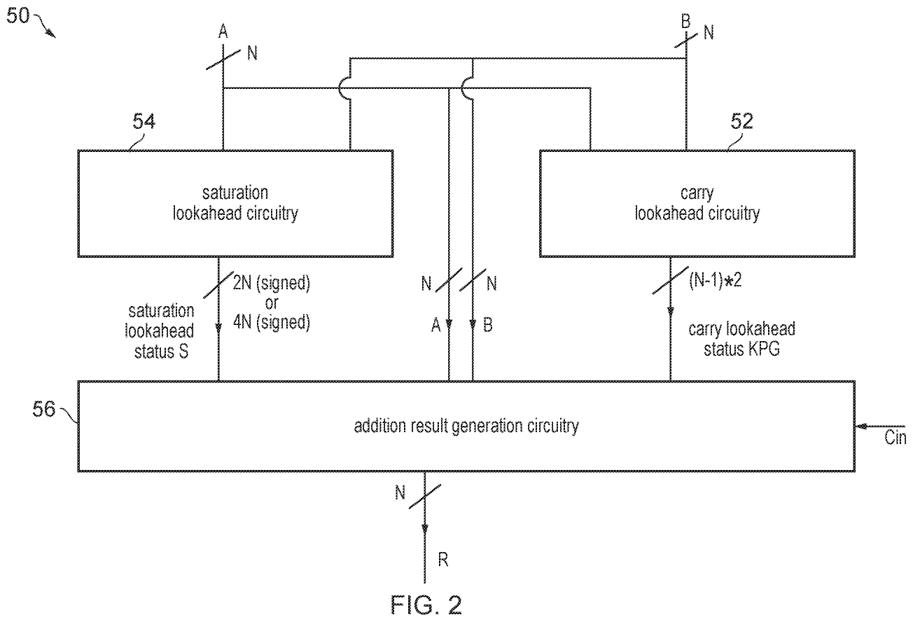

FIG. 2 illustrates an example of addition circuitry 50 for performing a saturating addition operation on first and second numbers A and B (represented in 2's complement form) to generate a result value R. A, B and R are all N-bit numbers (where N is an integer). For the examples shown in more detail below, N=8, but it will be appreciated that other examples could use different values for N, such as N=16, 32 or 64.

The addition circuitry comprises carry lookahead circuitry 52, saturation lookahead circuitry 54 and addition result generation circuitry 56.

The carry lookahead circuitry 52 generates a group of carry lookahead status indications, also referred to below as KPG (Kill, Propagate, Generate) values. A KPG value is generated for each lane of the addition (a lane comprising a bit of the result value and the correspondingly positioned bits of the first and second numbers A, B), other than the most significant lane. As discussed further below, a KPG value for a given lane indicates whether a carry out would be generated from the lane in the addition of the first and second numbers A, B, and has one of three states indicating whether the lane unconditionally does not produce a carry out (“kill”, or K), conditionally produces a carry conditional on whether there is a carry in to that lane (“propagate”, or P), or unconditionally will produce a carry out (“generate”, or G). The KPG value for a given lane can be computed based on the corresponding bits of the first and second numbers A, B in that lane and any less significant lanes. As KPG values are computed for N−1 of the lanes and each KPG value can be encoded using 2 bits to indicate one of the three states K, P and G, a total of (N−1)*2 bits of state are generated by the carry lookahead circuitry 52.

The saturation lookahead circuitry 52 generates a group of saturation lookahead status indications S. As discussed further below, a saturation lookahead status value for a given lane indicates whether the result bit in that lane should be set to represent part of the saturation value, and has one of three states indicating, respectively, that the lane is unconditionally not saturated (a first state), that the lane is unconditionally saturated (a second state), or that whether the lane should be saturated conditionally depends on a carry in to the lane (a third state). For unsigned saturation, one saturation lookahead status value is generated per lane, to indicate whether an unsigned overflow causes saturation. In this case, as there are N lanes and each saturation lookahead status value has one of three states, 2N bits of state can be generated for the saturation lookahead status values. For signed saturation, two saturation lookahead status values are generated per lane, respectively indicating whether a signed overflow causes saturation to the positive limit value of the allowable range for R, and whether a signed underflow causes saturation to the negative limit value of the allowable range for R. In this case, 4N bits of state can be generated for the saturation lookahead status values (2*2 bits for each of the N lanes).

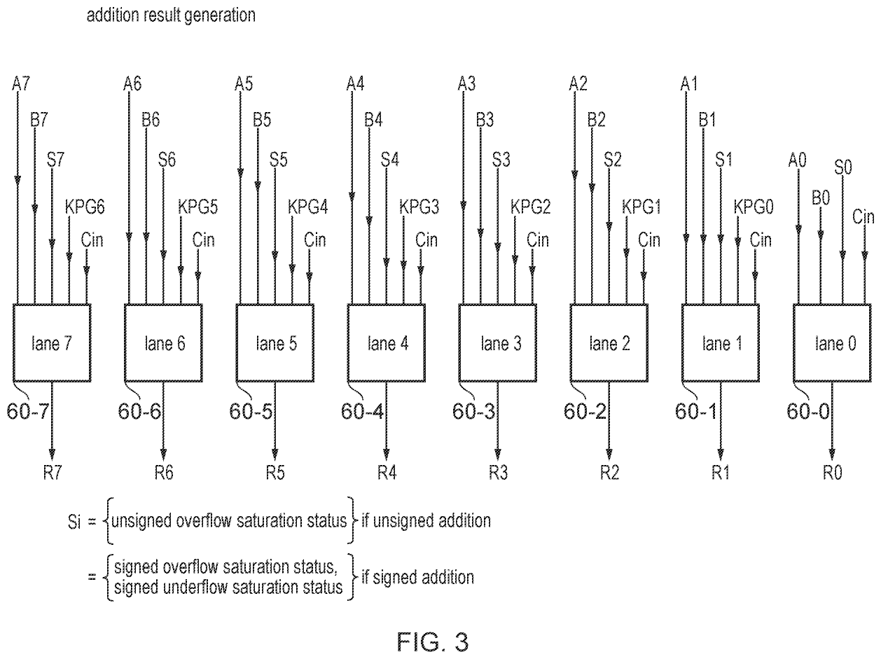

FIG. 3 shows the addition result generation circuitry 56 in more detail. The addition result generation circuitry 56 includes a number of result bit generating circuits (lane value generating circuits) 60-0 . . . 60-7 each for generating a corresponding bit R0 . . . R7 of the result value R. For a given lane i other than the least significant lane 0, the result bit Ri is generated as a function of:
a corresponding bit Ai of the first number A;
a corresponding bit Bi of the second number B;
the set of one or more saturation lookahead status values Si determined by saturation lookahead circuitry 54 for the given lane i;
the KPG value KPG(i−1) for the next least significant lane i−1; and
if the addition is an “add-with-carry” operation, a carry in value Cin representing the carry input to the least significant lane 0. If the addition is not an add-with-carry operation, the carry in value Cin can be assumed to be 0.

For the least significant lane, the result bit generating circuit 60-0 does not need to consider any KPG value as there is no less significant lane than that lane, so the result bit R0 depends on the corresponding bits A0, B0 of the first and second numbers, the one or more saturation lookahead status values S0 for that lane, and the carry in value Cin.

The result bit generating circuits 60-0 to 60-7 operate in parallel, lane by lane. This is made possible by the fact that the carry lookahead circuitry 52 and saturation lookahead circuitry 54 have computed the carry lookahead status values KPG0 . . . KPG6 and saturation lookahead status values S0 . . . S7 in advance, based on Boolean combinations of bits of A and B, without needing the full sum of A+B to be calculated based on a carry propagating addition (propagating carries from one lane to another sequentially would be slower). The carry lookahead status values KPG and the saturation lookahead status values can be computed with a delay time which scales with log₂(N) rather than with N, and so this approach helps to improve performance in comparison to a sequential carry propagating addition where each lane has to wait for the carry in to that lane to be calculated by the preceding lane before being processed. Also, as the saturation lookahead circuitry 54 computes in advance the indications of whether each lane of the result should be set to represent part of the saturation value, without waiting for an explicit sum value A+B to be calculated first, this also helps to improve performance because it allows the saturated result to be available sooner, with a gate delay commensurate with the gate delay used for non-saturating additions.

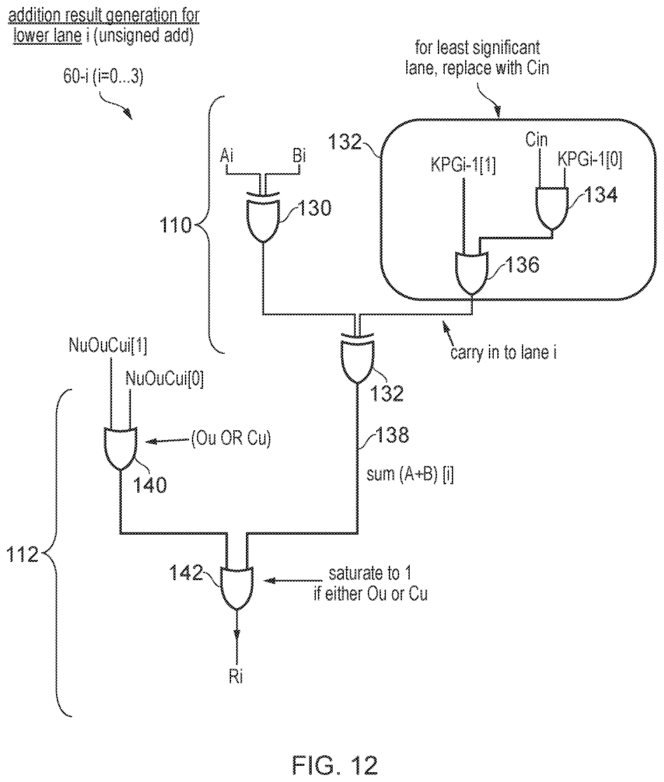

The particular function used to compute result bit Ri in a given lane depends on whether the saturation is an unsigned saturation or a signed saturation, and can also depend on which lane is being generated, as discussed in more detail below with respect to FIGS. 12 to 16. In the case of unsigned saturation, the function used to compute result bit Ri may also depend on whether the addition is an add operation or a subtract operation (since the saturation value to be used may be 0b1111 . . . for an add operation and 0 for a subtract operation). However, first the calculation of the KPG and saturation lookahead status values will be described.

### Carry Lookahead Status Circuitry

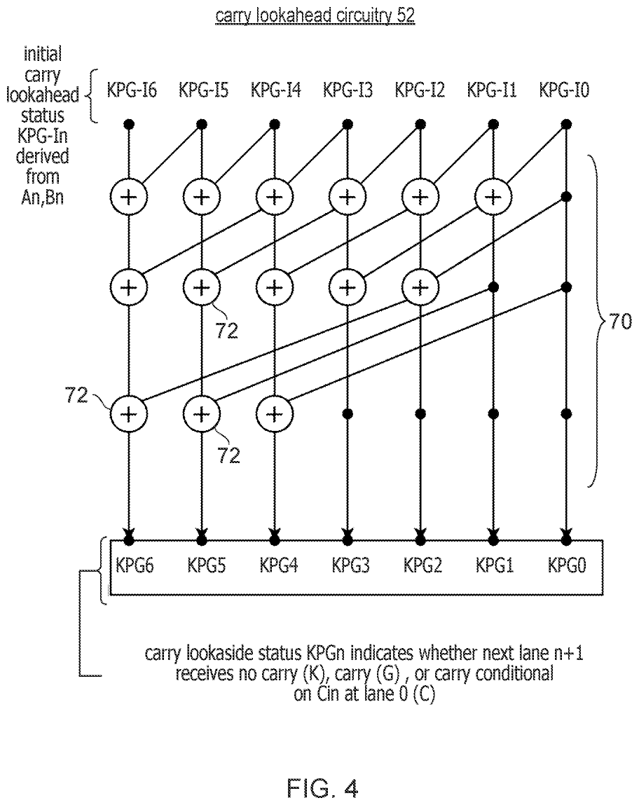

As shown in FIG. 4, for each bit lane of the addition (other than the most significant lane), the carry lookahead circuitry 52 computes an initial KPG (“Kill, Propagate, Generate”) value KPG-I0 . . . . KPG-I6. This value is a 3-way enumeration that represents the action of the bit-lane on the carry, where:
“K” represents a lane that does not produce a carry output regardless of whether it receives a carry input (selected if the A, B bits in that lane are both 0).
“P” represents a lane that produces a carry output only if it receives a carry input (selected if the A, B bits in that lane are either 0 and 1 or 1 and 0).
“G” represents a lane that produces a carry output regardless of whether it receives a carry input (selected if the A, B bits in that lane are both 1).

These initial KPG values can then be combined hierarchically-one can compute a KPG value for a 2-bit lane by combining the KPG values for two adjacent 1-bit lanes, then compute a KPG value for a 4-bit value by combining the KPG values for two adjacent 2-bit lanes, and so on.

The combiner function for the KPG values of two adjacent lanes is given by the following table:

KPG value of low lane

| | | K | P | G |
|---|---|---|---|---|
| KPG value of | K | K | K | K |
| high lane | P | K | P | G |
| | G | G | G | G |

For any given bit-position of the addition-result, the carry into the bit-position can be computed by hierarchically combining the KPG values of all lanes below the bit-position, then apply the resulting KPG value to the incoming carry-bit to bit position 0 (conventionally 0, except if add-with-carry is desired). For a non-saturating addition, the result bit Ri formed by the addition A+B in lane i would then become (A XOR B) XOR carry-in. Here, “carry-in” is 1 if the final combined KPG value for that lane is G or if the combined KPG value for that lane is P AND the incoming carry-bit Cin to bit position 0 is 1, and “carry-in” is 0 if the combined KPG value is K or if the combined KPG value is P AND Cin is 0. However, for a saturating addition, the result bit Ri also depends on the saturation lookahead status indication(s) S as discussed further below.

For an addition as a whole, it is worth noting that the combiner function above is associative, and as such, it is possible to perform the hierarchical KPG calculation for every bit-position in a highly logic-shared manner by using a parallel-prefix-sum network 70, as shown in FIG. 4. In particular, a Kogge-Stone parallel prefix sum network can be used. The parallel prefix-sum network 70 includes log₂(N) stages of combiner units 72 (in this example, three stages, as N=8). While the combiner units 72 are designated with a + symbol for ease of denoting a combination, it will be appreciated that they are not actually adding the incoming KPG values, but are instead combining them according to the combiner function shown in the table above.

The sequence of combinations performed by the parallel prefix-sum tree 70 is such that, by the end of the final stage of combiner units 72, the values of the KPG values correspond to bottom-up combinations of successively increasing numbers of initial KPG values KPG-I as follows:
KPG0=KPG-I0;
KPG1 corresponds to the combination of KPG-I0 and KPG-I1;
KPG2 corresponds to the combination of KPG-I0 to KPG-I2;
KPG3 corresponds to the combination of KPG-I0 to KPG-I3;
KPG4 corresponds to the combination of KPG-I0 to KPG-I4;
KPG5 corresponds to the combination of KPG-I0 to KPG-I5;
KPG6 corresponds to the combination of KPG-I0 to KPG-I6.

Here, carry lookahead status value KPGn indicates whether the next most significant lane n+1 receives no carry (K), a carry (G) or a carry conditional on Cin at lane 0 (P).

One implementation of the KPG values is to represent each KPG value (including the initial values KPG-I0 . . . . KPG-I6, any intermediate values generated by combiner units 72 in the parallel prefix-sum tree network 70, and the final KPG values output to the addition result generation circuitry 56) as a two-bit value as follows:
K=00, P=01, G=1× (both 10 and 11 interpreted as G)

This allows as implementation where combining two lanes can be done with an AND-gate for the low bit and an AND-OR gate for the high bit. It also allows a cheap computation of the initial 1-bit-lane KPG values (one OR gate+one AND gate per bit lane).

### Saturation Lookahead Status Circuitry for Unsigned Saturation

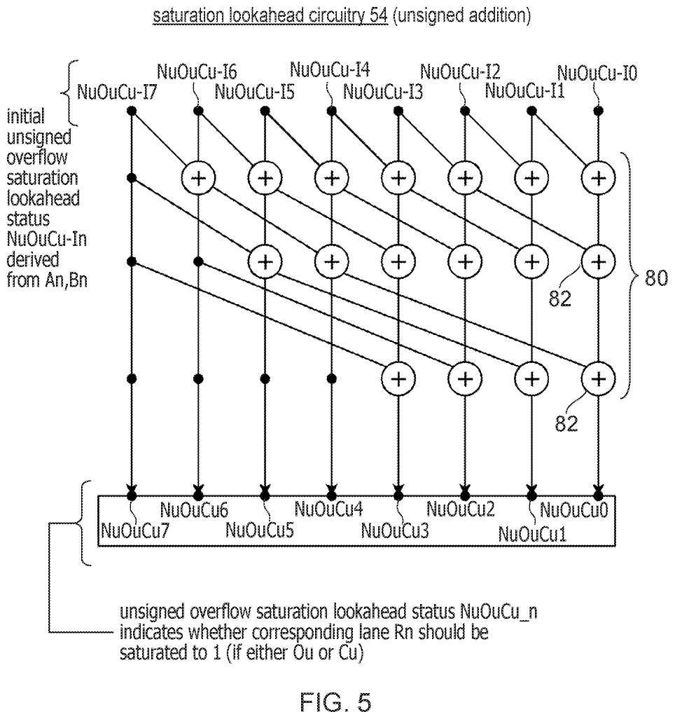

FIG. 5 illustrates an example of the saturation lookahead circuitry 54 for use in an addition with unsigned saturation. For unsigned saturation, it is possible to generate the saturation lookahead status values S for each lane by performing a similar computation to the generation of the KPG values by the carry lookahead circuitry 52. For each bit-lane, the saturation lookahead circuitry 54 computes an unsigned overflow saturation lookahead status value, referred to here as a NuOuCu value (“No-overflow”, “Overflow”, “Conditional-overflow”, unsigned variants)—this is a 3-valued enumeration that takes the following values:
Nu (“No-overflow”): The addition within this lane is not producing an unsigned overflow
Ou (“Overflow”): The addition within this lane is producing an unsigned overflow
Cu (“Conditional-overflow”): The addition within this lane is producing an unsigned overflow if carry input is set (i.e. the lane immediately below had an unsigned overflow).

Initial unsigned overflow saturation lookahead status values NuOuCu-10 to NuOuCu-17 are determined by the saturation lookahead circuitry 54 for each lane n (where n=0 . . . 7) based on the corresponding bits An, Bn of the first and second numbers, according to the following rules:
the initial value NuOuCu-In is set to Nu, if An and Bn are both 0;
the initial value NuOuCu-In is set to Ou, if An and Bn are both 1;
the initial value NuOuCu-In is set to Cu, if An and Bn are either 0 and 1 or 1 and 0.

Like KPG values, the NuOuCu values for two adjacent bit-lanes can be combined to compute a NuOuCu lane for a 2-bit lane—it is also possible to compute NuOuCu values for 4-bit lanes by combining values for adjacent 2-bit lanes, and then continue to combine values hierarchically up until the desired width is reached.

The combiner function is given by the following table:

NuOuCu value of low lane

| | | Nu | Cu | Ou |
|---|---|---|---|---|
| NuOuCu value of | Nu | Nu | Nu | Nu |
| high lane | Cu | Nu | Cu | Ou |
| | Ou | Ou | Ou | Ou |

For each bit-lane, we can determine the combined NuOuCu value of that bit-lane and all higher bit-lanes, to generate the final NuOuCu for each lane n which is used by the addition result generation circuitry 56 to form the result bit Rn in that lane. Since the combiner function above is associative, this can be done using a parallel-prefix-sum network 80 comprising log₂(N) stages of combiner units 82, similar to that for the carry lookahead circuitry 52, except that the combination order is top-down rather than bottom-up, and that NuOuCu values are computed for all N lanes rather than only for N−1 lanes.

The sequence of combinations performed by the parallel prefix-sum tree 80 of the saturation lookahead circuitry 54 is such that, by the end of the final stage of combiner units 82, the values of the NuOuCu values correspond to top-down combinations of successively increasing numbers of initial NuOuCu values NuOuCu-I as follows:
KPG7=KPG-I7;
KPG6 corresponds to the combination of KPG-I7 and KPG-I6;
KPG5 corresponds to the combination of KPG-I7 to KPG-I5;
KPG4 corresponds to the combination of KPG-I7 to KPG-I4;
KPG3 corresponds to the combination of KPG-I7 to KPG-I3;
KPG2 corresponds to the combination of KPG-I7 to KPG-I2;
KPG1 corresponds to the combination of KPG-I7 to KPG-I1.
KPG0 corresponds to the combination of KPG-I7 to KPG-I0.

If the value for a given bit-lane value ends up as Ou, then we know that the part of the addition above the bit-position—and therefore the addition as a whole—had an unsigned overflow and should be saturated to all-1s.

If the value ends up as Cu (“conditional-overflow”), then we know that the addition result for the given bit-lane and all higher bit-lanes is all-1s. This gives rise to two possible cases:
There is no carry from the lane below. In this case, there is no overflow, and the bit-lane (and all higher bit-lanes) ends up with the value 1. OR-ing a 1 into the lane is safe.
There is a carry from the lane below. In this case, the carry will propagate all the way up to the top of the number, setting all the high-order bits to 0 and causing an unsigned overflow. In this case, unsigned saturation requires OR-ing a 1 into the lane.

As such, the saturating addition as a whole can be represented as: Ri=(Ai+Bi) OR (Ou OR Cu), where the OR represents a bitwise-OR and Ai+Bi is shorthand for the (Ai XOR Bi) XOR carry-in determined based on the KPG values as discussed above with respect to FIG. 4.

In other words, the unsigned overflow saturation lookahead status indication NuOuCu_n generated for lane n by the saturation lookahead circuitry 54 indicates whether the bit Rn in the corresponding lane of the result value should be set to 1 (which will occur if either Ou or Cu is indicated by NuOuCu_n). It is noted that although Cu indicates a conditional overflow, the saturation of an individual bit lane to 1 is done unconditionally, without considering the carry in at the bottom lane, because the Cu case indicates that the addition result A+B would have had the value 0b11111111 having all bits set to 1, in which case the result will have to be 0b11111111 regardless of whether the carry in bit Cin was 0 (no saturation, so retain the addition result value A+B) or 1 (saturation, so clamp to all 1s). The Cu state is still distinguished in the NuOuCu values because of how it affects the combiner function when combining NuOuCu values for two subsets of lanes.

### Saturation Lookahead Status Circuitry for Signed Saturation

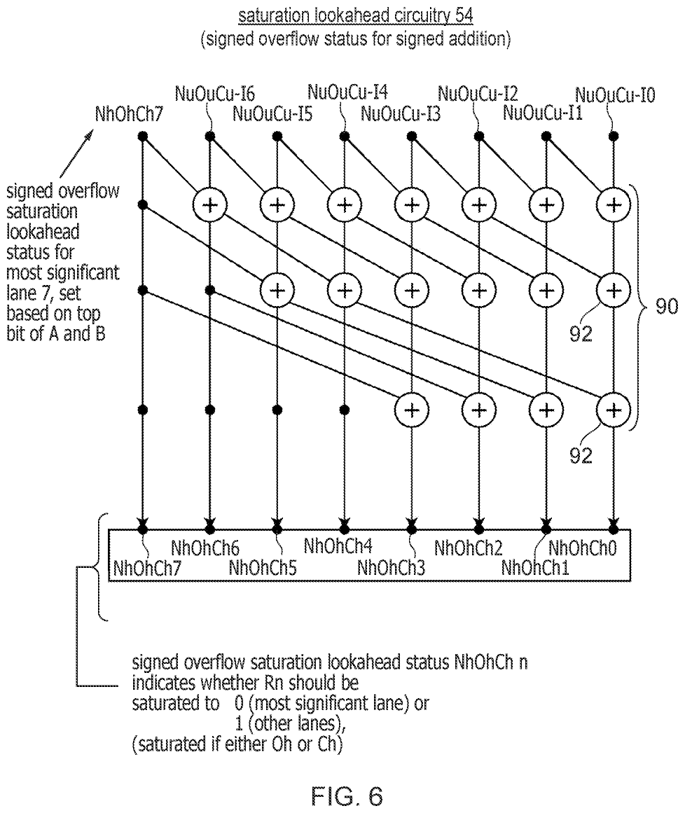

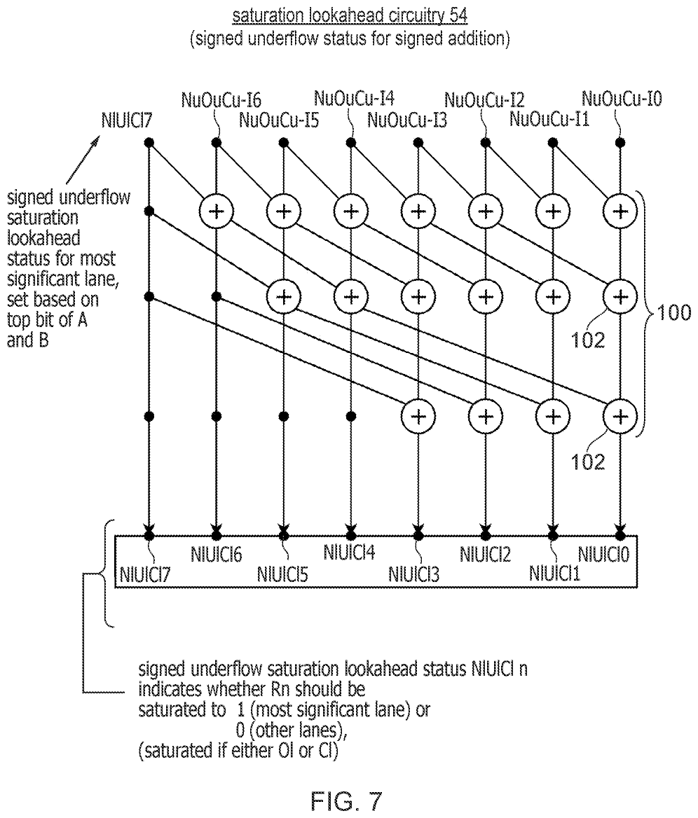

FIGS. 6 and 7 illustrate an example of the saturation lookahead circuitry 54 for use in an addition with signed saturation. For addition with signed saturation, we perform two checks—one for overflow and one for underflow, and therefore the saturation lookahead circuitry 54 comprises two instances of the parallel-prefix-sum network 90, 100, one for overflow (FIG. 6) and one for underflow (FIG. 7). Each instance of the parallel-prefix sum network has the same structure of combiner units 92, 102 as the network 80 shown for unsigned saturation in FIG. 5, but uses a different input value as the initial saturation lookahead status value for the most significant lane (the initial values for the other lanes are the same NuOuCu value as described above for unsigned saturation). The different behaviour in the upper lane reflects that for signed saturation, the wraparound point for saturation is from 0b01111111 to 0b10000000 for overflow and from 0b10000000 to 0b01111111 for underflow. The combiner functions used by each combiner unit 92, 102 in the overflow/underflow parallel-prefix-sum networks are similar to those used for unsigned saturation and can be calculated using identical circuit logic. In other words, it is only the initial value in the upper lane that differs compared to the unsigned saturation case.

For the overflow check, as shown in FIG. 6 we compute for the top bit an NhOhCh value. This is encoded as a 3-valued enumeration that can take the following values:
Nh (No signed overflow): the addition within this lane does not produce a signed overflow;
Oh (Signed overflow): the addition within this lane produces a signed overflow;
Ch (Conditional overflow): the addition within this lane will produce a signed overflow if there is a carry-in from the lane below.

However, the initial value (NhOhCh7 in FIG. 6) does not actually need to select Oh for the top bit lane. Instead, the encoding for Oh can be introduced for lower bit-lanes, if it arises from the combination of NhOhCh7 with the NuOuCu values for lower lanes when combined according to the combiner function shown in the table below.

The initial value NhOhCh7 for the upper lane 7 is set based on the top bits A7 and B7 of the numbers being added, according to the following rules:
select Ch if the most significant bit of A and the most significant bit of B are both 0;
select Nh otherwise (if either A or B has a most significant bit of 1).

For the other bit-lanes (not the most significant bit lane), we compute the initial NuOuCu values NuOuCu-I in the same way as for unsigned saturation.

The NhOhCh value for a given lane can be combined with the NuOuCu value of an adjacent lane below as follows, for form a new NhOhCh value:

NuOuCu value of low lane

| | | Nu | Cu | Ou |
|---|---|---|---|---|
| NhOhCh value of | Nh | Nh | Nh | Nh |
| high lane | Ch | Nh | Ch | Oh |
| | Oh | Oh | Oh | Oh |

This combination can be done hierarchically, as previously described for NuOuCu; for the signed-saturation, we compute for each bit-position an NhOhCh value by combining NhOhCh/NuOuCu values for that bit-lane and all the bit-lanes above it, using a parallel-prefix-sum network 90 comprising combiner units 92 as shown in FIG. 6.

The resulting signed overflow saturation lookahead status value NhOhCh for a given lane n indicates whether Rn should be set to 0 (if lane n is the most significant lane) or should be set to 1 (if lane n is any other lane), with that saturation occurring if NhOhCh for lane n indicates either Oh or Ch (again, although the Ch overflow is conditional on the carry in at the lower lane, setting the top lane to 0 and other lanes to 1 in this case gives the correct result even if there is no carry in).

Similarly, as shown in FIG. 7, for the underflow check, we compute for the top bit an NlUlCl value representing a signed underflow saturation lookahead status indication. This is a 3-valued enumeration with an encoding that can take the following values:
Nl: No signed underflow
Ul: Signed underflow
Cl: Signed Underflow unless carry-in from the lane below.

Again, the initial NlUlCl value for the upper lane 7 (NlUlCl7 in FIG. 7) is set based on the top bits A7, B7 of the numbers being added, according to the following rules:
select Cl if the most significant bit of A and the most significant bit of B are both 1;
select Nl otherwise (if either A or B has a most significant bit of 0).

It is not necessary to be able to select Ul for the top lane, but this encoding can be used for other lanes as it is introduced when needed based on the combiner function shown below. Again, for lanes other than the upper lane, initial NuOuCu values NuOuCu-16 to NuOuCu-10 are calculated in the same way as for unsigned saturation.

The NlUlCl value can be combined with the NuOuCu value of an adjacent lane below, to compute a new NlUlCl value as follows:

NuOuCu value of low lane

| | | Nu | Cu | Ou |
|---|---|---|---|---|
| NIUICI value of | UI | UI | UI | UI |
| high lane | CI | UI | CI | NI |
| | NI | NI | NI | NI |

Again, this is done hierarchically using a second instance of a parallel prefix sum network 100 comprising combiner units 102.

The resulting signed underflow saturation lookahead status value NlUlCl for a given lane n indicates whether Rn should be set to 1 (if lane n is the most significant lane) or should be set to 0 (if lane n is any other lane), with that saturation occurring if NlUlCl for lane n indicates either Ol or Cl.

### Hardware Circuit Logic Sharing Between Carry Lookahead Circuitry and Saturation Lookahead Circuitry

From the combiner function tables above, it can be seen that the new 3-valued datatypes for saturation detection (NuOuCu, NhOhCh, NlUlCl) and their combiner operations are similar to the KPG data types and combiners used for carry lookahead. By choosing an appropriate encoding of the values representing these data types, the similarity is indeed close enough that it is possible to have extensive logic-sharing between their parallel-prefix-sum networks, to reduce the total circuit area and power consumption of the addition circuitry 50 as a whole.

In particular, for the NuOuCu datatype, assigning its three values as {Nu=00, Cu=01, Ou=1×} will cause a parallel-prefix calculation to progress in a manner where the per-bit-lane initial-value and per-node calculation are bit-identical to that for the KPG calculation described above (with K=00, P=01, G=1×) and therefore can be performed using the same physical gates—with the only unshared logic being some bits at the ends, where the KPG calculation needs more low-order bits and NuOuCu calculation needs a few more high-order bits.

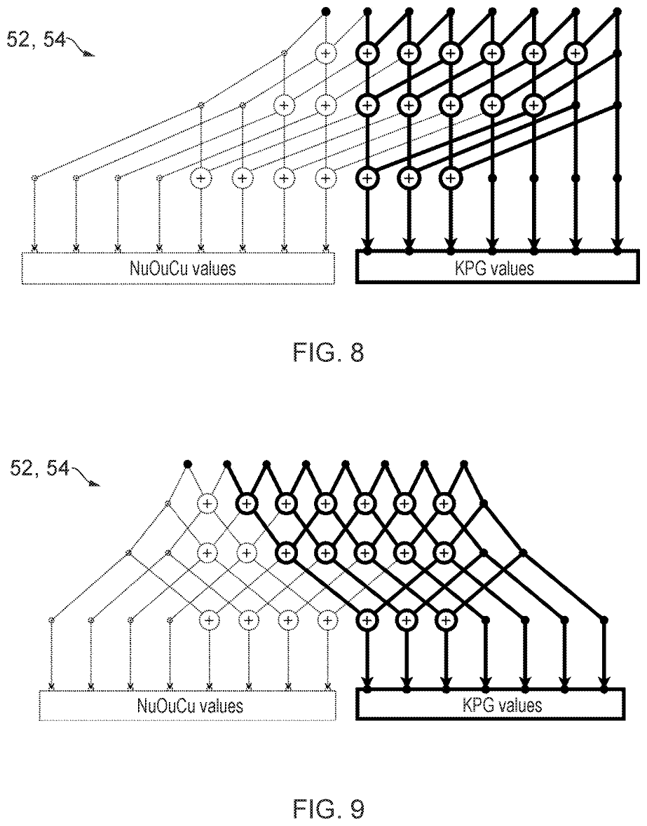

See FIG. 8, which shows shared Kogge-Stone networks for computation of KPG values for addition carry-propagation and NuOuCu values for unsigned saturation propagation in an 8-bit adder. The nodes needed for KPG values are highlighted with the solid black lines, and the added nodes needed for NuOuCu values are shown in finely-stippled lines.

FIG. 9 shows the same shared-Kogge-Stone network as in FIG. 8, but with the nodes aligned differently in order to highlight symmetry in the calculation.

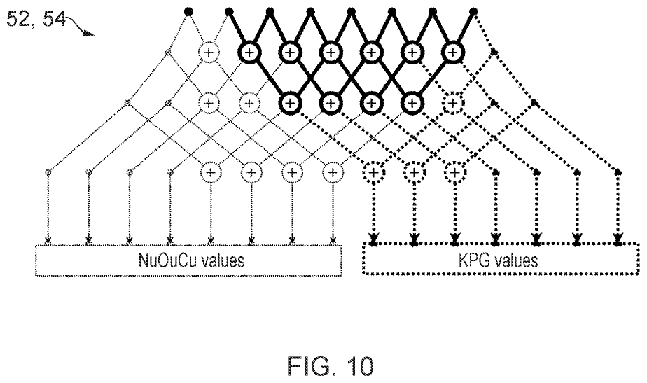

FIG. 10 shows the same shared-Kogge-Stone network as in FIGS. 8 and 9, but the nodes that are only needed for KPG-based carry computation are highlighted with coarse dashed stippling instead of solid lines. The nodes with solid lines are the ones that are fully logic-shared between the two calculations. The nodes in the finely-stippled lines are those needed only for the saturation lookahead calculation. Hence, it can be seen that 10 of the 21 nodes of the combined carry/saturation lookahead status circuitry 52, 54 can be fully logic-shared.

For the signed saturating addition, the calculation of the NhOhCh and NlUlCl values cannot be logic-shared, since they are needed as separate values. In FIG. 10, this means that the fine-stippled combiner nodes in the left half of the figure will contain duplicated logic, with each fine-stippled node in FIG. 10 comprising one instance of the corresponding combiner unit 92 from FIG. 6 and one instance of the corresponding combiner unit 102 from FIG. 7. Nevertheless, the solid-outlined nodes shown in FIG. 10 can still be fully logic shared with the carry lookahead circuitry 52. Also, if both the unsigned and signed saturation options are supported in the same circuit implementation, only two instances of the duplicated logic for the finely-stippled nodes are needed, as for the add with unsigned saturation the NuOuCu values can be calculated using one of the two instances of the duplicated logic provided for calculating the NhOhCh and NlUlCl values for the add with signed saturation.

### Different Ordering of Applying the Carry Lookahead Status Values and Saturation Lookahead Status Values for the Upper and Lower Lanes of the Result

From the above, the saturating addition appears to require the base addition-result A+B to be subjected to a bitwise-OR (or bitwise-AND-OR for signed-saturating addition), which appears to add extra latency over a basic addition. However, with some careful logic rearrangement, this added latency can be removed.

The KPG bits determined for carry propagation can be computed faster for the low half of the addition than for the high half of the addition, with the difference making up typically one AND-OR-INVERT gate. This is because, as shown in FIG. 4, for the carry lookahead circuitry 52, the KPG values for lanes 0 to 3 can be available following either 0, 1 or 2 stages of combination, while the KPG values for lanes 4 to 6 require 3 stages of combination.

On the other hand, for a saturating addition, the NuOuCu values described above show the opposite behavior: as shown in FIG. 5, they can be computed faster for the high half of the addition than for the low half, with the difference making up typically one AND-OR-INVERT gate. This is because the NuOuCu values for lanes 0 to 3 require 3 stages of combination while the NuOuCu values for lanes 4 to 7 require either 2, 1 or 0 stages of combination.

As such, for the low half of the addition, the KPG bits will appear a full AND-OR-INVERT delay before the NuOuCu bits, and as such we can apply the KPG bits in full before the NuOuCu bits arrive, with a total result latency for these bits no worse than the latency for the high-order bits of a regular non-saturating addition.

For the high half of the addition, the opposite situation is present: the NuOuCu bits will arrive a full AND-OR-INVERT delay before the KPG bits, and as such we can apply the NuOuCu bits before the KPG bits before the KPG bits arrive—with the result that we can compute the high-order bits just as fast as for a regular non-saturating addition.

This does however raise a question-since we don't actually have an addition result to apply the NuOuCu bits to, what kind of data are the NuOuCu bits supposed to be applied to? At this point, let's reconsider the addition calculation a bit: recall that

A+B=(A XOR B) XOR carry_in, where carry_in comes from the KPG calculation

This calculation can be reformulated to replace the final XOR with a MUX (multiplexer):

$$ABX = A XOR B$$

$$nABX = not ( A XOR B )$$

$$A + B = carry\_in ? ABX : nABX$$

where the “?:” operators represent a per-bit-lane MUX, selecting between the candidate values ABX and nABX depending on the value of carry_in.

With this reformulation, we can then apply the NuOuCu bits to the ABX and nABX values separately—in parallel with waiting for the last KPG bits—for each bit-position, the carry_in will then select either the modified ABX or the modified nABX value (the modified ABX value being ABX=ABX OR (Ou or Cu) and the modified nABX value being (nABX OR (Ou OR Cu)).

In most modern silicon HW processes, a MUX is generally about as fast as a XOR gate, so replacing the final XOR with a MUX does not add any significant latency.

A similar approach can be taken for speeding up the addition result generation for adds with signed saturation.

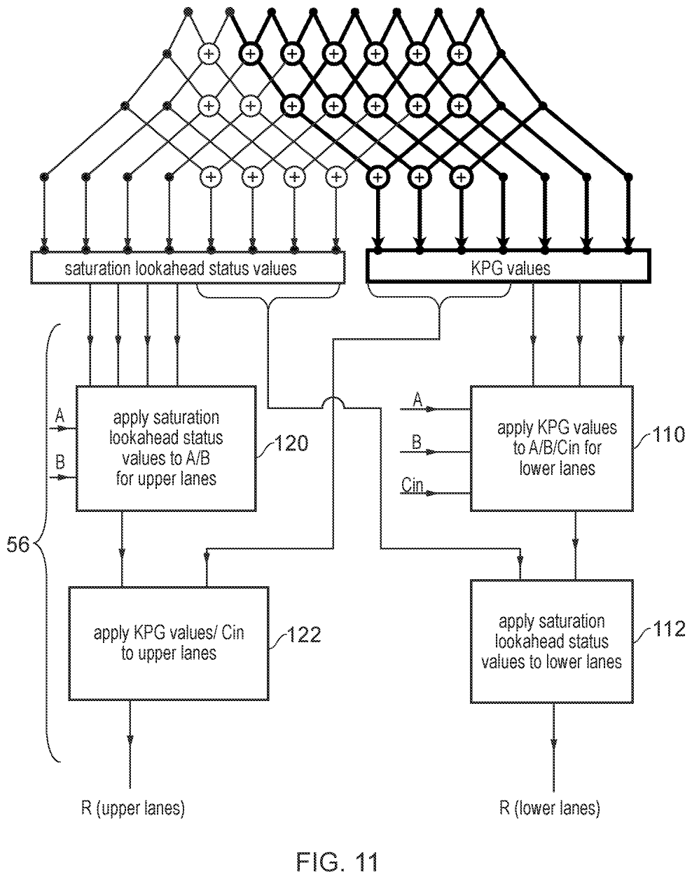

Hence, as shown in FIG. 11, the addition result generation circuitry 56 can be designed so that, for a lane in a less significant subset of lanes of the result value, the addition result generating circuitry is configured to apply the carry lookahead status indication KPG to the corresponding bits of the first number A and the second number B (see block 110), before applying the corresponding set of one or more saturation lookahead status indications S (see block 112); and for a lane in a more significant subset of lanes of the result value, the addition result generating circuitry is configured to apply the corresponding set of one or more saturation lookahead status indications to the corresponding bits of the first number and the second number (see block 120), before applying the carry lookahead status indication (see block 122). For example, the more significant subset of lanes may comprise lanes 4 to 7 and the less significant subset of lanes may comprise lanes 0 to 3 (although it is noted that in lane 0 there is no KPG value to apply based on a lower lane).

FIGS. 12 to 16 illustrate more specific examples of circuitry for the result bit generating units 60-i for respective lanes, implementing the principle shown in FIG. 11. This forms part of the addition result generating circuitry 56 within the addition circuitry 50. These examples all assume an encoding of the saturation lookahead status indications where 0b00 indicates Nu/Nh/Nl, 0b01 indicates Cu/Ch/Cl and 0b1x indicates Ou/Oh/Ul. It will be appreciated that other encodings could also be used, but the encoding shown here may be particularly efficient in terms of circuit area. It will also be appreciated that the same Boolean functions could be implemented using a different collection of gates, e.g. with a different order of applying the Boolean operations.

FIG. 12 illustrates an example of circuitry for the result bit generating unit 60-i corresponding to a lower lane (e.g. i=0 to 3), for an example using unsigned saturation. As shown in FIG. 12, the result bit generating unit 60-i has blocks 110, 112 of circuit logic to apply the KPG value before applying the saturation lookahead status indication NuOuCu.

Block 110 comprises:
XOR gate 130: determining Ai XOR Bi (exclusive OR of corresponding bits in lane i of the first and second numbers A and B);
block 132, for determining a carry in to lane i.
   If lane i is the least significant lane 0, this will simply be the value of Cin, where Cin represents the carry in operand to lane 0 for an add-with-carry-in operation or a value fixed to 0 for an add-without-carry-in. For lane 0, there is no relevant KPG value for a less significant lane.
   If lane i is a lane in the less significant subset of lanes other than the least significant lane 0, then the carry in to lane i is determined by:
      AND gate 134, which determines Cin AND bit [0] of KPG(i−1)—the output of AND gate 134 will be 1 if Cin is set AND KPG(i−1) indicates P (Propagate);
   OR gate 136, which ORs the output of AND gate 134 with bit [1] of KPG(i−1)—the output of OR gate 136 will be 1 if either KPG(i−1) indicates G (Generate) or if Cin is set and KPG(i−1) indicates P.
XOR gate 137: determines the exclusive OR of the carry in generated by block 132 and the result of XOR gate 130, to form a value 138 which represents the bit that would be set in lane i of the result if there was no saturation (i.e. bit i of sum (A+B)=Ai XOR Bi XOR carry-in, where carry-in is 1 if either KPG is Ou or KPG is Cu AND Cin is 1). Block 112 comprises:
an OR gate 140 to OR bits 1 and 0 of NuOuCu for lane i, which provides a value indicating whether the corresponding bit Ri of the result should be saturated to 1 (as explained above, although Cu indicates a conditional saturation depending on whether Cin is 0 or 1, in practice it is safe to always saturate Ri to 1 when NuOuCu for lane i indicates Cu, because when NuOuCu indicates Cu then the sum result will already be 1 anyway).
A second OR gate 142, which ORs the result of OR gate 140 with the sum bit calculated by XOR gate 138, to produce the corresponding bit Ri of the result value for lane i.

Hence, the result Ri calculated in FIG. 12 represents the saturating addition bit result for lane i according to the function US(A+B)=(A+B) OR (Ou OR Cu), where A+B is the bit value the corresponding lane would have had in a regular non-saturating addition according to (A XOR B) XOR carry-in. By implementing the KPG-processing circuit block 132 for the lower lane at an earlier stage of the circuit logic than the input of the NuOuCu value as shown in FIG. 12, this allows for faster processing because of the KPG value for the lower lane being available earlier than NuOuCu.

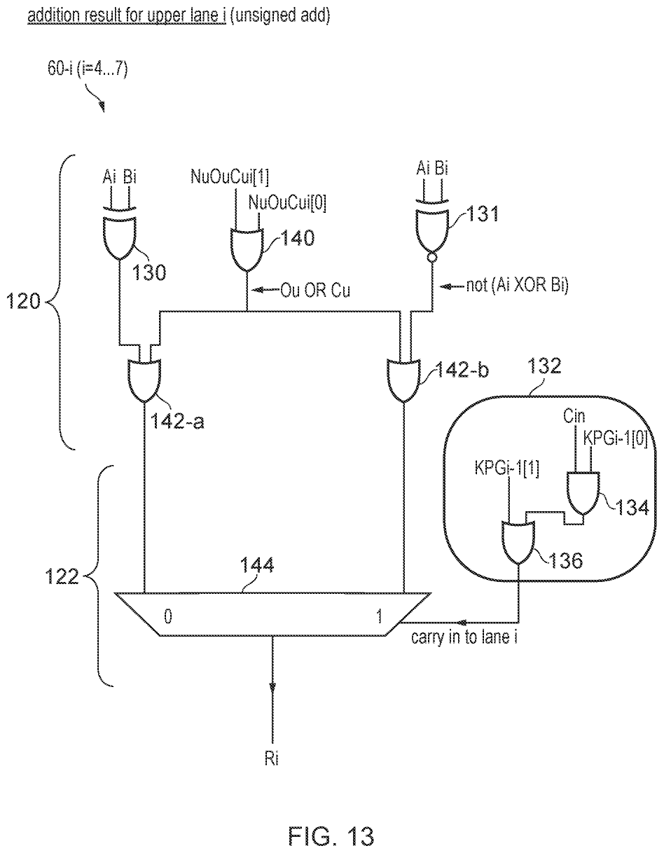

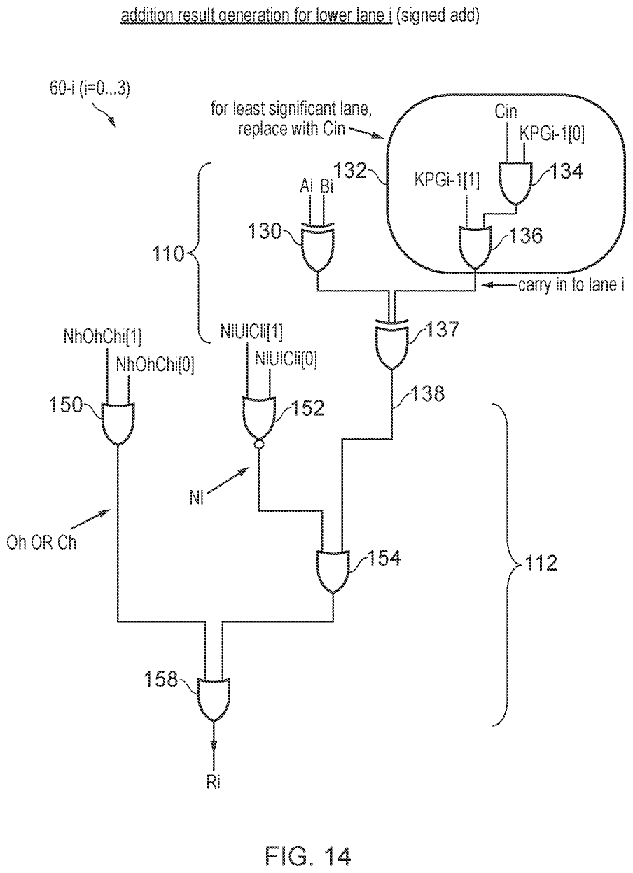

FIG. 13 illustrates an example of circuitry for the result bit generating unit 60-i corresponding to an upper lane (e.g. i=4 to 7), for an example using unsigned saturation. This evaluates the same function US(A+B)=(A+B) OR (Ou OR Cu) as in FIG. 12, but in a different order. As the KPG values for lanes 4 to 7 are available later than the NuOuCu values, block 132 which calculates the carry in is moved later on in the sequence of operations. As the carry in value calculated by block 132 could modify the sum value (A+B), two candidate values are calculated based on Ai, Bi and NuOuCu, corresponding to the outcomes in the case that the carry in value from block 132 is set or not set (if set, it would cause the sum value (A+B) to flip states from Ai XOR Bi).

Hence, in block 120, the first candidate value is generated by:
XOR gate 130, which generates the XOR of Ai and Bi;
OR gate 140, which generates the OR of the two bits of NuOuCu for lane i—this will be 1 if NuOuCu indicates either Ou or Cu;
OR gate 142-a, which generates the OR of the outputs of gates 130, 140—this applies any required saturation to the value of bit i of sum (A+B) which would be generated in the case where there is no carry in to lane i.
   Similarly, in block 120, the second candidate value is generated by:
XNOR gate 131, which generates the exclusive NOR (i.e. inverse of XOR from gate 130) of Ai and Bi;
OR gate 142-b, which ORs the outputs of gates 131 and 140—this applies the saturation to the value of bit i of sum (A+B) which would be generated in the case where there is a carry in to lane i.

A multiplexer 144 in block 122 of the result bit generating unit 60-i selects between the two candidate values from gates 142-a and 142-b depending on the carry in to lane i. The carry in is calculated using block 132 in the same way as shown in FIG. 12 for lanes other than lane 0. The multiplexer 144 selects the saturation-modified version of Ai XOR Bi from OR gate 142-a if the carry in is 0, and selects the saturation-modified version of Ai XNOR Bi from OR gate 142-b if the carry in is 1.

The value selected by multiplexer 144 is output as result bit Ri for lane i.

Hence, by using a different ordering of the logic for the upper lanes (FIG. 13) compared to the lower lanes (FIG. 12), both subsets of lanes can generate their result quicker, resulting in a faster generation of the result of the saturating addition.

FIGS. 12 and 13 show an example where the saturation value has all bits set to 1, for an unsigned saturating add operation. If unsigned saturation subtract operations are to be supported, this can be done in a similar way, but with the Ri bits for each lane clamped to 0 instead in the overflow case. Also, as described earlier the second number B would be negated prior to determining the KPG and saturation lookahead status values.

FIGS. 14 to 16 show similar examples of result bit generating units for respective lanes in a saturating add with signed saturation. For signed saturation, having computed an NlUlCl value and an NhOhCh value for each lane, for all bits of the addition result other than the top bit, the addition result generating circuitry 56 proceeds to:
Bitwise-OR the addition result with (Oh OR Ch)—this applies the positive-value saturation (overflow saturation);
Bitwise-AND the addition result with Nl—this applies the negative-value saturation (underflow saturation).

On the other hand, for the top bit of the addition result, the addition result generating circuitry 56 proceeds to:
Bitwise-AND the addition result with NOT(Oh OR Ch)—this applies the positive-value saturation (overflow saturation);
Bitwise-OR the addition result with NOT(Nl)—this applies the negative-value saturation (underflow saturation)

The bitwise-AND and the bitwise-OR are both applied to the result, one after another. They may be applied in any order, although it has been observed that applying the bitwise-AND first gives a very slightly faster circuit in synthesis. Hence, the examples of FIGS. 14 to 16 apply the AND before the OR, although other examples could do this the other way round.

FIG. 14 shows, for signed saturation, the result bit generating unit 60-i for a lane i in the less significant subset of lanes 0 to 3. Block 110, comprising XOR gates 130, 137, AND gate 134 and OR gate 136, is the same as in FIG. 12. However, block 112 is different to FIG. 12, to reflect that there can be two types of saturation: signed overflow and signed underflow. Block 112 comprises:
OR gate 150, which ORs the two bits of NhOhCh for lane i together, to provide a value which will be 0 if NhOhCh indicates Nh and 1 if Oh or Ch;
NOR gate 152, which generates the NOR of the two bits of NlUlCl for lane i, to provide a value which is 1 if NlUlCl indicates Nl and 0 if it indicates Ul or Cl;
AND gate 154 is provided to AND the result of NOR gate 152 with the addition result 138 from block 110; and
OR gate 158 is provided to OR the results of OR gate 150 and AND gate 154.
   This implements the function described above for generating the bits of the addition result other than the top bit, while exploiting the KPG bits being available before the NhOhCh/NlUlCl values for the lower lanes. It would be possible to reorder the gates, e.g. with the order of AND gate 154 and OR gate 158 being swapped.

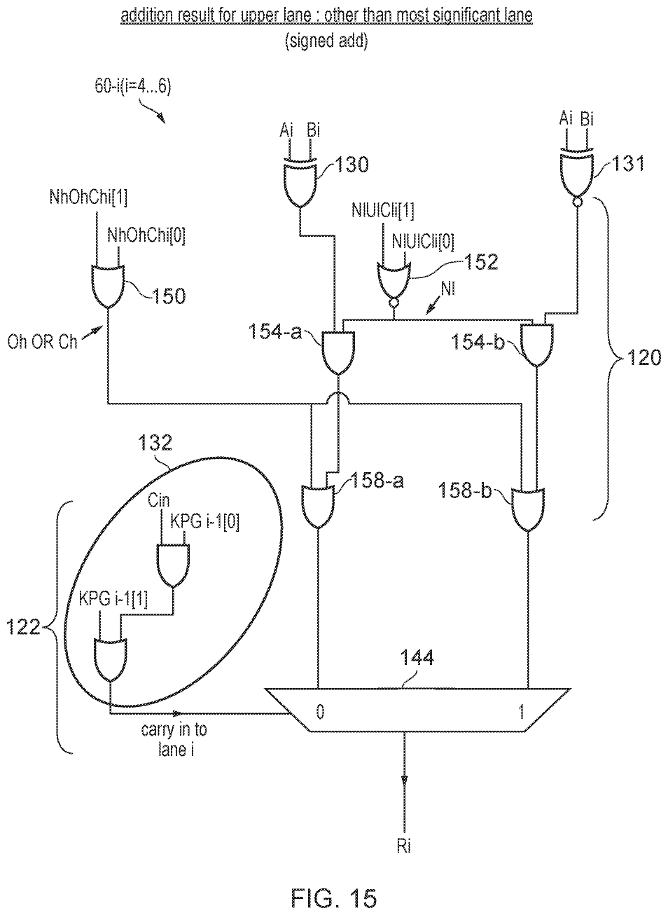

FIG. 15 shows, for signed saturation, the result bit generating unit 60-i for a lane i in the more significant subset of lanes 4 to 6, other than the most significant lane 7. As in FIG. 13, the logic comprises blocks 120 and 122 to apply the saturation lookahead status values and then the KPG values. Block 122 is the same as in FIG. 13. Block 120 is structured in a similar way to FIG. 13, to generate two candidate values for selection by multiplexer 144 based on the carry in value. However, block 120 differs from FIG. 13 in the functions used to apply the saturation lookahead status values. Each candidate value is generated by a set of OR, NOR, AND, OR gates 150, 152, 154, 158 implementing the same function as the corresponding gates in FIG. 14, but AND/OR gates 154, 158 are duplicated so that the first candidate values is derived from Ai XOR Bi calculated by XOR gate 130 and the second candidate value is derived from Ai XNOR Bi calculated by XNOR gate 131, similar to FIG. 13. The OR and NOR gates 150, 152 (respectively for combining the two bits of NhOhCh for the signed overflow saturation and combining the two bits of NlUlCl for the signed underflow saturation) do not need to be duplicated and provide the same value to each of the duplicated OR gates 158-a, 158-b and AND gates 154-a, 154-b respectively. Again, the AND 154-a/b and OR 158-a/b are applied in that order to speed up processing. As in FIG. 13, by using the multiplexer 144 to select between candidate values corresponding to modified (based on signed saturation) versions of A XOR B and A XNOR B respectively, this enables the saturation lookahead status values to be applied before the KPG values to shorten the overall gate delay.

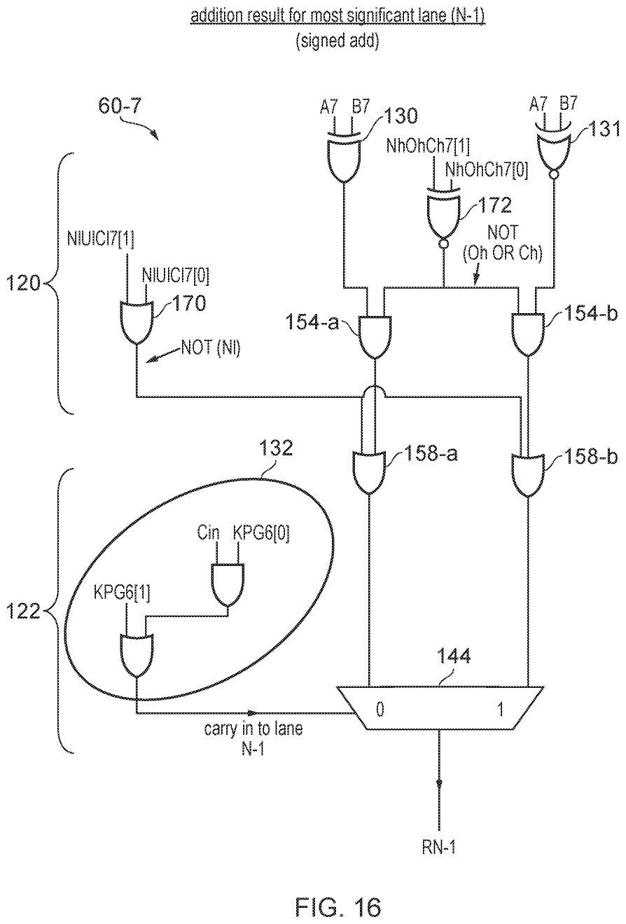

FIG. 16 shows, for signed saturation, the result bit generating unit 60-7 for the most significant lane 7. Block 122 is the same as in FIGS. 13 and 15. Block 120 has a similar arrangement to FIG. 15, to calculate two candidate values for selection by multiplexer 144 based on the modified (by saturation if necessary) values of Ai XOR Bi and Ai XNOR Bi. However, OR gate 150 in FIG. 15 is replaced with OR gate 170 in FIG. 16 which ORs the two bits of NlUlCl for lane 7 (i.e. the signed underflow saturation lookahead status, rather than the signed overflow saturation lookahead status as in OR gate 150 in FIG. 15). The output of OR gate 170 represents “NOT(Nl)” as shown above. NOR gate 152 in FIG. 15 is replaced with NOR gate 172 in FIG. 16 which NORs the two bits of NhOhCh for lane 7 (the signed overflow saturation lookahead status, rather than the signed underflow saturation lookahead status as in NOR gate 170 of FIG. 15). This represents NOT (Oh OR Ch) mentioned above. Hence, effectively the inputs of OR gate 170 and NOR gate 172 have been swapped relative to the corresponding gates 150, 152 in FIG. 15. The result is that for the top lane the saturation is in the opposite direction to the lower lanes-saturation on a signed overflow causes the top lane of the result to be set to 0 and saturation on a signed underflow causes the top lane of the result to be set to 1. Again, the approach shown in FIG. 16 allows the result to be ready faster due to applying the saturation lookahead status values before the KPG values.

For signed saturating subtract operations, the same addition result generation logic shown in FIGS. 14 to 16 can be used as for signed saturating add operations. Hence, other than negating the second number B prior to generating the KPG and saturation lookahead status values, the signed saturating subtract operation can be performed in the same way as a signed saturating add operation.

FIGS. 14 to 16 are just one example of how the bit results for each lane Ri can be calculated based on the respective bits of A and B, the saturation lookahead status indications for lane i and the carry lookahead status indication for the preceding lane. However, it will be appreciated that the same result could be generated by a different combination of gates.

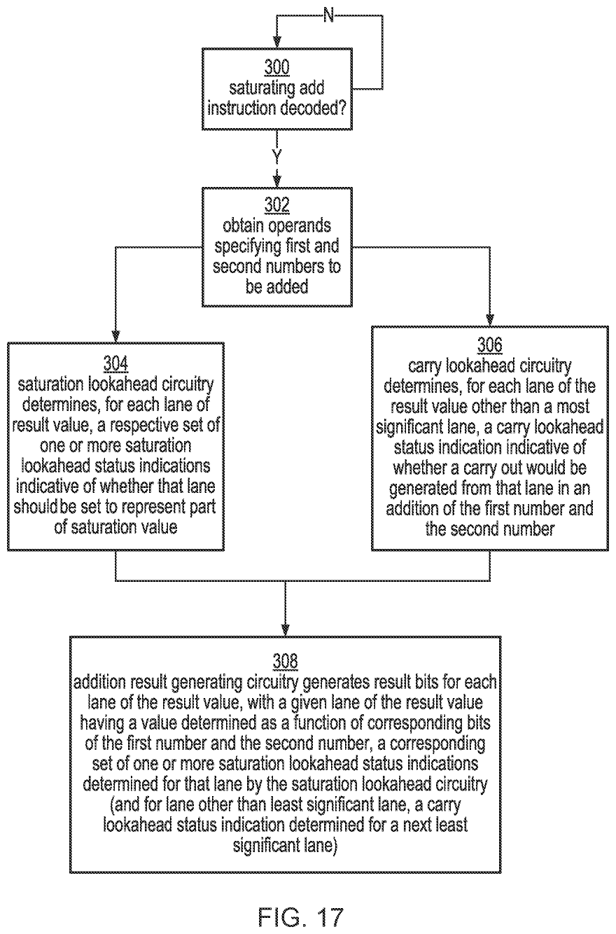

FIG. 17 shows a flow diagram illustrating a method of processing a saturating addition instruction (encompassing both addition and subtraction operations). At step 300, the saturating add instruction is decoded by instruction decoder 10 of the pipeline 4. In response, at step 302, the execute stage 16 of the pipeline obtains the operands specifying the first and second numbers A, B to be added or subtracted (and if the instruction is an add-with-carry instruction, also obtains the carry in value Cin). The operands are provided to the addition circuitry 50.

At step 304, the saturation lookahead circuitry 54 determines, for each lane of result value, a respective set of one or more saturation lookahead status indications indicative of whether that lane should be set to represent part of saturation value. In parallel with step 304, at step 306 the carry lookahead circuitry 52 determines, for each lane of the result value other than a most significant lane, a carry lookahead status indication indicative of whether a carry out would be generated from that lane in an addition of the first number and the second number.

At step 308, the addition result generating circuitry 56 generates result bits for each lane of the result value, with a given lane of the result value having a value determined as a function of corresponding bits of the first number and the second number, a corresponding set of one or more saturation lookahead status indications determined for that lane by the saturation lookahead circuitry (and for lane other than least significant lane, a carry lookahead status indication determined for a next least significant lane).

### Code for Fabrication

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Examples are set out in the following clauses:
1. An apparatus comprising:
   addition circuitry to perform a saturating addition of a first number and a second number to generate a result value, the result value indicating an addition result corresponding to addition of the first number and the second number when the addition result is within a predetermined range and indicating a saturation value when the addition result is outside the predetermined range;
   the addition circuitry comprising:
      saturation lookahead circuitry to determine, for each lane of the result value, a respective set of one or more saturation lookahead status indications indicative of whether that lane of the result value should be set to represent part of the saturation value; and
      addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.
2. The apparatus according to clause 1, in which the saturation lookahead circuitry is configured to:
   determine initial saturation lookahead status indications for each lane based on corresponding bits of the first number and the second number for that particular lane; and
   combine the initial saturation lookahead status indications to generate the saturation lookahead status indications for lanes other than the most significant lane, where a given saturation lookahead status indication for a given lane other than a most significant lane depends on a combination of the initial saturation lookahead status indications for the given lane and any more significant lane than the given lane.
3. The apparatus according to clause 2, in which the saturation lookahead circuitry is configured to combine the initial saturation lookahead status indications using a top-down parallel-prefix-sum network.
4. The apparatus according to any preceding clause, the addition circuitry comprising carry lookahead circuitry to determine a plurality of carry lookahead status indications each corresponding to a respective lane of the result value other than a most significant lane, each carry lookahead status indication indicative of whether a carry out would be generated from a corresponding lane in an addition of the first number and the second number; and
   for a lane of the result value other than a least significant lane, the addition result generating circuitry is configured to generate that lane of the result value as a function of the corresponding bits of the first number and the second number, the corresponding set of one or more saturation lookahead status indications determined for that lane by the saturation lookahead circuitry, and the carry lookahead status indication determined for a next least significant lane by the carry lookahead circuitry.
5. The apparatus according to claim 4, in which the carry lookahead circuitry is configured to:
   determine initial carry lookahead status indications for each lane other than the most significant lane, based on corresponding bits of the first number and the second number; and
   combine the initial carry lookahead status indications to generate the carry lookahead status indications for lanes other than the least significant lane, where a given carry lookahead status indication for a given lane other than a least significant lane and the most significant lane depends on a combination of the initial carry lookahead status indications for the given lane and any less significant lane than the given lane.
6. The apparatus according to claim 5, in which the carry lookahead circuitry is configured to combine the initial carry lookahead status indications using a bottom-up parallel-prefix-sum network.
7. The apparatus according to any of clauses 4 and 5, in which the saturation lookahead circuitry and the carry lookahead circuitry share a portion of hardware circuit logic used for both determination of the saturation lookahead status indication for at least one lane and determination of the carry lookahead status indication for at least one lane.
8. The apparatus according to any of clauses 4 to 7, in which:
   for a lane in a less significant subset of lanes of the result value, the addition result generating circuitry is configured to apply the carry lookahead status indication to the corresponding bits of the first number and the second number, before applying the corresponding set of one or more saturation lookahead status indications; and
   for a lane in a more significant subset of lanes of the result value, the addition result generating circuitry is configured to apply the corresponding set of one or more saturation lookahead status indications to the corresponding bits of the first number and the second number, before applying the carry lookahead status indication.
9. The apparatus according to claim 8, in which for the lane in the more significant subset of lanes of the result value, the addition result generating circuitry is configured to generate first and second candidate values for that lane of the result value based on the corresponding bits of the first number and the second number and the corresponding set of one or more saturation lookahead status indications, and to select between the first and second candidate values based on a carry value derived from the carry lookahead status indication.
10. The apparatus according to any of clauses 2, 3 and 4 to 9 when dependent on clause 2, the saturation lookahead circuitry is configured to determine the initial saturation lookahead status indication for each lane to indicate one of:
   a first state, in a case where addition of the corresponding bits of the first number and the second number would not produce an overflow or underflow;
   a second state, in a case where addition of the corresponding bits of the first number and the second number would unconditionally produce an overflow or underflow; and
   a third state, in a case where whether or not an addition of the corresponding bits of the first number and the second number conditionally produces an overflow or underflow, conditional on whether a carry input for that lane is set.
11. The apparatus according to claim 10, in which when combining saturation lookahead status indications for first and second lane subsets each comprising one or more lanes, where the second lane subset is less significant than the first lane subset, the saturation lookahead circuitry is configured to:
   determine that a combined saturation lookahead status indication for the first and second lane subsets has the first state, when the saturation lookahead status indication for the first lane subset has the first state;
   determine that the combined saturation lookahead status indication for the first and second lane subsets has the second state, when the saturation lookahead status indication for the first lane subset has the second state; and determine that the combined saturation lookahead status indication for the first and second lane subsets is equal to the saturation lookahead status indication for the second lane subset, when the saturation lookahead status indication for the first lane subset has the third state.
12. The apparatus according to any preceding clause, in which for an unsigned saturating addition where the predetermined range extends from zero to a positive limit value, the saturation lookahead circuitry is configured to generate an unsigned overflow saturation lookahead status indication for each lane indicative of whether the corresponding lane should be set to part of the saturation value; and the addition result generating circuitry is configured to generate the given lane with a value determined as a function of corresponding bits of the first number and the second number and the unsigned overflow saturation lookahead status indication determined for that lane by the saturation lookahead circuitry.
13. The apparatus according to any preceding clause, in which for a signed saturating addition where the predetermined range extends from a negative limit value to a positive limit value, the saturation value is the negative limit value when the addition result is a negative number of greater magnitude than the negative limit value, and the saturation value is the positive limit value when the addition result is a positive number of greater magnitude than the positive limit value, the saturation lookahead circuitry is configured to generate, for each lane:
   a signed overflow saturation lookahead status indication indicative of whether a corresponding lane should be set to part of the positive limit value; and
   a signed underflow saturation lookahead status indication indicative of whether the corresponding lane should be set to part of the negative limit value; and
the addition result generating circuitry is configured to generate the given lane with a value determined as a function of corresponding bits of the first number and the second number and the signed overflow saturation lookahead status indication and the signed underflow saturation lookahead status indication determined for that lane by the saturation lookahead circuitry.
14. The apparatus according to claim 13, in which the saturation lookahead circuitry is configured to:
determine the signed overflow saturation lookahead status indication and the signed underflow lookahead status indication for a most significant lane, based on corresponding bits of the first number and the second number for the most significant lane;
determine, for lanes other than the most significant lane, initial unsigned overflow saturation lookahead status indications for each lane indicative of whether addition of corresponding bits of the first number and the second number would produce an unsigned overflow; and
generate, for a given lane other than the most significant lane:
   a signed overflow saturation lookahead status indication based on a combination of the initial signed overflow saturation lookahead status indication for the most significant lane and one or more initial unsigned overflow saturation lookahead status indications for the given lane and any lane more significant lane than the given lane but less significant than the most significant lane; and.
   a signed underflow saturation lookahead status indication based on a combination of the initial signed underflow saturation lookahead status indication for the most significant lane and one or more initial unsigned overflow saturation lookahead status indications for the given lane and any lane more significant lane than the given lane but less significant than the most significant lane.
15. The apparatus according to any of clauses 13 and 14, in which the addition result generating circuitry is configured to:
for a most significant lane, determine whether to saturate the lane to 0 depending on the signed overflow saturation lookahead status indication determined by the saturation lookahead circuitry for the most significant lane, and determine whether to saturate the lane to 1 depending on the signed underflow saturation lookahead status indication determined by the saturation lookahead circuitry for the most significant lane; and
for lanes other than the most significant lane, determine whether to saturate the lane to 1 depending on the signed overflow saturation lookahead status indication determined by the saturation lookahead circuitry for the most significant lane, and determine whether to saturate the lane to 0 depending on the signed underflow saturation lookahead status indication determined by the saturation lookahead circuitry for the most significant lane.
16. A computer-readable medium to store computer-readable code for fabrication of an apparatus comprising:
   addition circuitry to perform a saturating addition of a first number and a second number to generate a result value, the result value indicating an addition result corresponding to addition of the first number and the second number when the sum is within a predetermined range and indicating a saturation value when the addition result is outside the predetermined range;
   the addition circuitry comprising:
      saturation lookahead circuitry to determine, for each lane of the result value, a respective set of one or more saturation lookahead status indications indicative of whether that lane of the result value should be set to represent part of the saturation value; and
      addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.
17. A method for performing, using addition circuitry comprising saturation lookahead circuitry and addition result generating circuitry, a saturating addition of a first number and a second number to generate a result value, the result value indicating an addition result corresponding to addition of the first number and the second number when the addition result is within a predetermined range and indicating a saturation value when the addition result is outside the predetermined range; the method comprising:
   determining, for each lane of the result value using the saturation lookahead circuitry, a respective set of one or more saturation lookahead status indications indicative of whether that lane of the result value should be set to represent part of the saturation value; and
   generating result bits for each lane of the result value using the addition result generating circuitry, with a given lane of the result value having a value determined as a function of corresponding bits of the first number and the second number and a corresponding set of one or more saturation lookahead status indications determined for that lane by the saturation lookahead circuitry.
18. The method of claim 17, in which:
   the addition circuitry comprises carry lookahead circuitry;
   the method comprises determining, using the carry lookahead circuitry, a plurality of carry lookahead status indications each corresponding to a respective lane of the result value other than a most significant lane, each carry lookahead status indication indicative of whether a carry out would be generated from a corresponding lane in an addition of the first number and the second number; and
   for a lane of the result value other than a least significant lane, the addition result generating circuitry generates that lane of the result value as a function of the corresponding bits of the first number and the second number, the corresponding set of one or more saturation lookahead status indications determined for that lane by the saturation lookahead circuitry, and the carry lookahead status indication determined for a next least significant lane by the carry lookahead circuitry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
addition circuitry to perform a saturating addition of a first number and a second number to generate a result value, the result value indicating an addition result corresponding to addition of the first number and the second number when the addition result is within a predetermined range and indicating a saturation value when the addition result is outside the predetermined range;
the addition circuitry comprising:
saturation lookahead circuitry to determine, for each lane of the result value, a respective set of one or more saturation lookahead status indications indicative of whether that lane of the result value should be set to represent part of the saturation value; and
addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.

2. The apparatus according to claim 1, in which the saturation lookahead circuitry is configured to:
determine initial saturation lookahead status indications for each lane based on corresponding bits of the first number and the second number for that particular lane; and
combine the initial saturation lookahead status indications to generate the saturation lookahead status indications for lanes other than the most significant lane, where a given saturation lookahead status indication for a given lane other than a most significant lane depends on a combination of the initial saturation lookahead status indications for the given lane and any more significant lane than the given lane.

3. The apparatus according to claim 2, in which the saturation lookahead circuitry is configured to combine the initial saturation lookahead status indications using a top-down parallel-prefix-sum network.

4. The apparatus according to claim 1, the addition circuitry comprising carry lookahead circuitry to determine a plurality of carry lookahead status indications each corresponding to a respective lane of the result value other than a most significant lane, each carry lookahead status indication indicative of whether a carry out would be generated from a corresponding lane in an addition of the first number and the second number; and
for a lane of the result value other than a least significant lane, the addition result generating circuitry is configured to generate that lane of the result value as a function of the corresponding bits of the first number and the second number, the corresponding set of one or more saturation lookahead status indications determined for that lane by the saturation lookahead circuitry, and the carry lookahead status indication determined for a next least significant lane by the carry lookahead circuitry.

5. The apparatus according to claim 4, in which the carry lookahead circuitry is configured to:
determine initial carry lookahead status indications for each lane other than the most significant lane, based on corresponding bits of the first number and the second number; and
combine the initial carry lookahead status indications to generate the carry lookahead status indications for lanes other than the least significant lane, where a given carry lookahead status indication for a given lane other than a least significant lane and the most significant lane depends on a combination of the initial carry lookahead status indications for the given lane and any less significant lane than the given lane.

6. The apparatus according to claim 5, in which the carry lookahead circuitry is configured to combine the initial carry lookahead status indications using a bottom-up parallel-prefix-sum network.

7. The apparatus according to claim 4, in which the saturation lookahead circuitry and the carry lookahead circuitry share a portion of hardware circuit logic used for both determination of the saturation lookahead status indication for at least one lane and determination of the carry lookahead status indication for at least one lane.

8. The apparatus according to claim 4, in which:
for a lane in a less significant subset of lanes of the result value, the addition result generating circuitry is configured to apply the carry lookahead status indication to the corresponding bits of the first number and the second number, before applying the corresponding set of one or more saturation lookahead status indications; and
for a lane in a more significant subset of lanes of the result value, the addition result generating circuitry is configured to apply the corresponding set of one or more saturation lookahead status indications to the corresponding bits of the first number and the second number, before applying the carry lookahead status indication.

9. The apparatus according to claim 8, in which for the lane in the more significant subset of lanes of the result value, the addition result generating circuitry is configured to generate first and second candidate values for that lane of the result value based on the corresponding bits of the first number and the second number and the corresponding set of one or more saturation lookahead status indications, and to select between the first and second candidate values based on a carry value derived from the carry lookahead status indication.

10. The apparatus according to claim 2, the saturation lookahead circuitry is configured to determine the initial saturation lookahead status indication for each lane to indicate one of:
a first state, in a case where addition of the corresponding bits of the first number and the second number would not produce an overflow or underflow;
a second state, in a case where addition of the corresponding bits of the first number and the second number would unconditionally produce an overflow or underflow; and
a third state, in a case where whether or not an addition of the corresponding bits of the first number and the second number produces an overflow or underflow is conditional on whether a carry input for that lane is set.

11. The apparatus according to claim 10, in which when combining saturation lookahead status indications for first and second lane subsets each comprising one or more lanes, where the second lane subset is less significant than the first lane subset, the saturation lookahead circuitry is configured to:
determine that a combined saturation lookahead status indication for the first and second lane subsets has the first state, when the saturation lookahead status indication for the first lane subset has the first state;
determine that the combined saturation lookahead status indication for the first and second lane subsets has the second state, when the saturation lookahead status indication for the first lane subset has the second state; and
determine that the combined saturation lookahead status indication for the first and second lane subsets is equal to the saturation lookahead status indication for the second lane subset, when the saturation lookahead status indication for the first lane subset has the third state.

12. The apparatus according to claim 1, in which for an unsigned saturating addition where the predetermined range extends from zero to a positive limit value, the saturation lookahead circuitry is configured to generate an unsigned overflow saturation lookahead status indication for each lane indicative of whether the corresponding lane should be set to part of the saturation value; and
the addition result generating circuitry is configured to generate the given lane with a value determined as a function of corresponding bits of the first number and the second number and the unsigned overflow saturation lookahead status indication determined for that lane by the saturation lookahead circuitry.

13. The apparatus according to claim 1, in which for a signed saturating addition where the predetermined range extends from a negative limit value to a positive limit value, the saturation value is the negative limit value when the addition result is a negative number of greater magnitude than the negative limit value, and the saturation value is the positive limit value when the addition result is a positive number of greater magnitude than the positive limit value, the saturation lookahead circuitry is configured to generate, for each lane:
a signed overflow saturation lookahead status indication indicative of whether a corresponding lane should be set to part of the positive limit value; and
a signed underflow saturation lookahead status indication indicative of whether the corresponding lane should be set to part of the negative limit value; and
the addition result generating circuitry is configured to generate the given lane with a value determined as a function of corresponding bits of the first number and the second number and the signed overflow saturation lookahead status indication and the signed underflow saturation lookahead status indication determined for that lane by the saturation lookahead circuitry.

14. The apparatus according to claim 13, in which the saturation lookahead circuitry is configured to:
determine the signed overflow saturation lookahead status indication and the signed underflow lookahead status indication for a most significant lane, based on corresponding bits of the first number and the second number for the most significant lane;
determine, for lanes other than the most significant lane, initial unsigned overflow saturation lookahead status indications for each lane indicative of whether addition of corresponding bits of the first number and the second number would produce an unsigned overflow; and
generate, for a given lane other than the most significant lane:
a signed overflow saturation lookahead status indication based on a combination of the initial signed overflow saturation lookahead status indication for the most significant lane and one or more initial unsigned overflow saturation lookahead status indications for the given lane and any lane more significant lane than the given lane but less significant than the most significant lane; and.
a signed underflow saturation lookahead status indication based on a combination of the initial signed underflow saturation lookahead status indication for the most significant lane and one or more initial unsigned overflow saturation lookahead status indications for the given lane and any lane more significant lane than the given lane but less significant than the most significant lane.

15. The apparatus according to claim 13, in which the addition result generating circuitry is configured to:
for a most significant lane, determine whether to saturate the lane to 0 depending on the signed overflow saturation lookahead status indication determined by the saturation lookahead circuitry for the most significant lane, and determine whether to saturate the lane to 1 depending on the signed underflow saturation lookahead status indication determined by the saturation lookahead circuitry for the most significant lane; and
for lanes other than the most significant lane, determine whether to saturate the lane to 1 depending on the signed overflow saturation lookahead status indication determined by the saturation lookahead circuitry for the most significant lane, and determine whether to saturate the lane to 0 depending on the signed underflow saturation lookahead status indication determined by the saturation lookahead circuitry for the most significant lane.

16. A non-transitory computer-readable medium to store computer-readable code for fabrication of an apparatus comprising:
addition circuitry to perform a saturating addition of a first number and a second number to generate a result value, the result value indicating an addition result corresponding to addition of the first number and the second number when the sum is within a predetermined range and indicating a saturation value when the addition result is outside the predetermined range;
the addition circuitry comprising:
saturation lookahead circuitry to determine, for each lane of the result value, a respective set of one or more saturation lookahead status indications indicative of whether that lane of the result value should be set to represent part of the saturation value; and
addition result generating circuitry to generate result bits for each lane of the result value, with a given lane of the result value having a value determined as a function of corresponding bits of the first number and the second number and a corresponding set of one or more saturation lookahead status indications determined for that lane by the saturation lookahead circuitry.

17. A method for performing, using addition circuitry comprising saturation lookahead circuitry and addition result generating circuitry, a saturating addition of a first number and a second number to generate a result value, the result value indicating an addition result corresponding to addition of the first number and the second number when the addition result is within a predetermined range and indicating a saturation value when the addition result is outside the predetermined range; the method comprising:
determining, for each lane of the result value using the saturation lookahead circuitry, a respective set of one or more saturation lookahead status indications indicative of whether that lane of the result value should be set to represent part of the saturation value; and
generating result bits for each lane of the result value using the addition result generating circuitry, with a given lane of the result value having a value determined as a function of corresponding bits of the first number and the second number and a corresponding set of one or more saturation lookahead status indications determined for that lane by the saturation lookahead circuitry.

18. The method of claim 17, in which:
the addition circuitry comprises carry lookahead circuitry;
the method comprises determining, using the carry lookahead circuitry, a plurality of carry lookahead status indications each corresponding to a respective lane of the result value other than a most significant lane, each carry lookahead status indication indicative of whether a carry out would be generated from a corresponding lane in an addition of the first number and the second number; and
for a lane of the result value other than a least significant lane, the addition result generating circuitry generates that lane of the result value as a function of the corresponding bits of the first number and the second number, the corresponding set of one or more saturation lookahead status indications determined for that lane by the saturation lookahead circuitry, and the carry lookahead status indication determined for a next least significant lane by the carry lookahead circuitry.
